(19) United States
(12) Patent Application Publication
(10) Pub. No.: US 2016/0077267 A1
(43) Pub. Date: Mar. 17, 2016

(54) POLARIZING PLATE AND DISPLAY DEVICE THEREWITH

(71) Applicant: KONICA MINOLTA, INC., Tokyo (JP)

(72) Inventor: Shinji INAGAKI, Tokyo (JP)

(73) Assignee: KONICA MINOLTA, INC., Chiyoda-ku, Tokyo (JP)

(21) Appl. No.: 14/786,252

(22) PCT Filed: May 13, 2014
(86) PCT No.: PCT/JP2014/062649

§ 371 Date: Oct. 22, 2015

(30) Foreign Application Priority Data
May 17, 2013 (JP) 2013-105540
Jul. 19, 2013 (JP) 2013-150617

(51) Int. Cl. G02B 5/30; C09J 129/02; G02F 1/13363

(52) U.S. Cl. CPC G02B 5/3083; G02F 1/13363; C09J 129/02; G02F 2001/133638

(57) ABSTRACT

A polarizing plate, wherein a λ/4 film and a cured layer which includes a UV-curable resin are layered in this order on one side of a polarizer via an adhesive layer. The thickness of the λ/4 film is 10 μm to 70 μm. The adhesive layer bonds the polarizer and the λ/4 film by a state change from a liquid state. The cured layer includes an organic compound having a UV-absorbing function.

### TECHNICAL FIELD

The present invention relates to a polarizing plate having a quarter-wave film (λ/A film) and a curing layer of an ultraviolet ray-curable resin at one face of a polarizer, and also relates to a display device provided with such a polarizing plate.

### BACKGROUND ART

Polarized sun glasses are conventionally known as means for reducing incident light. Polarized sun glasses are composed of a polarizing film held between two lenses. Of the incident light, only linearly polarized light parallel to the transmission axis (perpendicular to the absorption axis) of the polarizing film is transmitted through the polarizing film. Thus, wearing polarized sun glasses helps alleviate the wearer's being dazzled.

To a viewer viewing a liquid crystal display device through polarized sun glasses, depending on the model and the viewing angle, the screen may appear dim or deformed. This results from a deviation between the transmission axis of the polarizing plate disposed on the viewer's side of the liquid crystal display device and the transmission axis of the polarizing film in the polarized sun glasses. In particular with such appliances as are often viewed through polarized sun glasses, like vehicle navigators, vehicle-mounted instruments, aircraft panels, cellular telephones, PDAs (personal digital assistants, i.e., portable information terminals), motorized fishing reels, and fish finders, etc., users may experience difficulty acquiring information.

As a solution, according to a generally know technique, in a liquid crystal display device, further outside the viewer-side polarizing plate (on the side of the polarizing plate opposite from the liquid crystal layer), a quarter-wave film is provided so that, by converting the linearly polarized light transmitted through the polarizing plate into circularly polarized light with the quarter-wave film, the displayed image is prevented from becoming less visible due to the above-mentioned deviation between the transmission axes. For example, according to Patent Document 1, a polarizing plate is built by bonding a quarter-wave film with a film thickness of 80 nm to a polarizer via a polyvinyl alcohol adhesive and providing an ultraviolet ray-curable hard-coat layer on the side of the quarter-wave film opposite from the polarizer. On the other hand, according to Patent Document 2, a polarizing plate is built by bonding a quarter-wave film to a polarizer via a sticking layer and providing, on the side of the quarter-wave film opposite from the polarizer, a resin layer having a hard-coat property and an ultraviolet ray cutting capability. This resin layer contains, as an ultraviolet ray absorber, an inorganic compound such as a metal oxide (e.g., titanium oxide) in the form of fine particles.

### LIST OF CITATIONS

### Patent Literature

Patent Document 1: JP-A-2008-83307 (see claim 1; paragraphs [0547], [0556], [0557], to [0569]; FIG. 2; etc.)

Patent Document 2: JP-A-2010-151910 (see claims 1, 2; paragraphs [0006], [0008], [0014], [0076]; etc.)

### SUMMARY OF THE INVENTION

### Technical Problem

These days, needs for medium- to small-size portable display devices as exemplified by cellular phones and PDAs (hereinafter collectively mobile devices) are rapidly increasing. Accordingly, further compactness and slimness are sought in mobile devices, and with this trend, further thinness is sought in (each layer constituting) polarizing plates used in mobile devices.

In producing thin polarizing plates, it is effective (1) to use a thin-film quarter-wave film with a film thickness of 70 nm or less, and (2) to use, instead of a sticking layer which tends to have a large film thickness (e.g., 10 nm), an adhesive layer which has a small film thickness (e.g., 3 nm or less). For an adhesive layer with a small film thickness, it is possible to use adhesive that bonds together the quarter-wave film and the polarizer by phase change from a liquid phase, one effective example being polyvinyl alcohol adhesive (water glue) used in Patent Document 1.

Inconveniently, however, when a polarizing plate was actually built by stacking a thin-film quarter-wave film with a film thickness of 70 μm or less and a hard-coat layer in this order on a polarizer via an adhesive layer, then a liquid crystal display device incorporating the polarizing plate was subjected to a durability test, and then visibility of the displayed image was evaluated through polarized sun glasses, a new problem was encountered: degraded visibility in a peripheral part of the screen. Through a study of this degradation in visibility, it was found out that during the durability test, minute cracks developed in a part of the quarter-wave film corresponding to a peripheral part of the screen, or the hard-coat layer separated from the quarter-wave film in peripheral part of the screen.

As for cracks in the quarter-wave film, seeing that the quarter-wave film is firmly bonded to the polarizer by the adhesive layer, and that the hard-coat layer is firmly bonded to the quarter-wave film by curing by being irradiated with ultraviolet rays, the cause is considered to be stress acting on the thin-film quarter-wave film both from the polarizer side and from the hard-coat layer side during the durability test. As for exfoliation of the hard-coat layer, seeing that the quarter-wave film is firmly bonded to the polarizer by the adhesive layer, the cause is considered to be the quarter-wave film contracting as the polarizer contracts during the durability test. In particular where, as disclosed in Patent Document 2, the hard-coat layer contains inorganic fine particles, the presence of the inorganic fine particles around the interface between the hard-coat layer and the quarter-wave film diminishes the closeness of contact between the two layers, and this is considered to make the hard-coat layer more likely to separate during the durability test.

Thus, in cases where use is made of a polarizing plate having a thin-film quarter-wave film and a hard-coat layer (curing layer) stacked in this order on a polarizer via an adhesive layer, with a view to suppressing degradation in the visibility of the displayed image through polarized sun glasses, it is desirable that the polarizing plate be so configured as to suppress cracks in the quarter-wave film and exfoliation of the curing layer during durability tests.

Against the background discussed above, an object of the present invention is to provide a thin polarizing plate that can suppress cracks in the quarter-wave film and exfoliation of the curing layer during durability tests, and to provide a display device incorporating such a polarizing plate so as to suppress degradation in the visibility of the displayed image through polarized sun glasses.

### Means for Solving the Problem

The above object of the present invention is achieved with the configurations described below.

1. A polarizing plate having
a quarter-wave film and
a curing layer formed of an ultraviolet ray-curable resin

stacked in this order at one face of a polarizer via an adhesive layer,

wherein

the quarter-wave film has a thickness of 10 μm to 70 μm,

the adhesive layer bonds together the polarizer and the quarter-wave film by phase change from a liquid phase, and

the curing layer contains an organic compound capable of absorbing ultraviolet rays.

2. The polarizing plate described at 1 above, wherein the slow axis of the quarter-wave film and the absorption axis of the polarizer intersect at an angle of 30° to 60°.

3. The polarizing plate described at 1 or 2 above, wherein, let the thickness of the adhesive layer be A μm, then
0 μm<A≦5 μm.

4. The polarizing plate described at any one of 1 to 3 above, wherein, let the thickness of the polarizer be B μm, then
1 μm<B≦15 μm.

5. The polarizing plate described at any one of 1 to 4 above, wherein the polarizer and the quarter-wave film are each in the form of a long film, and the slow axis of the quarter-wave film is inclined at 30° to 60° relative to the length direction of the quarter-wave film.

6. The polarizing plate described at any one of 1 to 5 above, wherein the quarter-wave film contains a cellulose-based polymer or a polycarbonate-based polymer.

7. The polarizing plate described at any one of 1 to 6, above wherein the adhesive layer is formed of a polyvinyl alcohol adhesive.

8. The polarizing plate described at any one of 1 to 6 above, wherein the adhesive layer is formed of an ultraviolet ray-curable adhesive.

9. The polarizing plate described at any one of 1 to 8 above, wherein an overcoat layer is formed on the curing layer.

10. The polarizing plate described at 9 above, wherein the overcoat layer is a hard-coat layer.

11. A display device comprising a display cell and a polarizing plate disposed at one face of the display cell,

wherein the polarizing plate is the polarizing plate described at any one of 1 to 4 above or the polarizing plate described at any one of 6 to 10 above referring to any one of 1 to 4 above.

12. The display device described at 11 above, further including a front window as an exterior cover at the side of the polarizing plate opposite from the display cell.

13. The display device described at 12 above, wherein a filler fills between the front window and the polarizing plate.

### Advantageous Effects of the Invention

With a polarizing plate having any of the configurations described above, despite a thin configuration where a thin-film quarter-wave film is bonded to a polarizer via an adhesive layer, it is possible to suppress cracks in the quarter-wave film and exfoliation of the curing layer. Consequently, it is possible to suppress, for a viewer wearing polarized sun glasses, degradation in the visibility of the image displayed on a display device incorporating the polarizing plate.

### BRIEF DESCRIPTION OF DRAWINGS

FIG. 1 is a sectional view showing an outline structure of a display device according to one embodiment of the present invention;

FIG. 2 is a sectional view showing another structure of a polarizing plate applicable to the above display device;

FIG. 3 is a plan view schematically showing an outline configuration of an obliquely stretched film production apparatus used in the embodiment;

FIG. 4 is a plan view schematically showing one example of a rail pattern in a stretching portion of the above production apparatus; and

FIG. 5 is a sectional view showing an outline structure of an organic EL image display device according to the embodiment.

### DESCRIPTION OF EMBODIMENTS

An embodiment of the present invention will be described below with reference to the accompanying drawings. In the present description, for any range of values from A to B, it is supposed that the range includes both the lower limit A and the upper limit B.

[Structure of a Display Device]

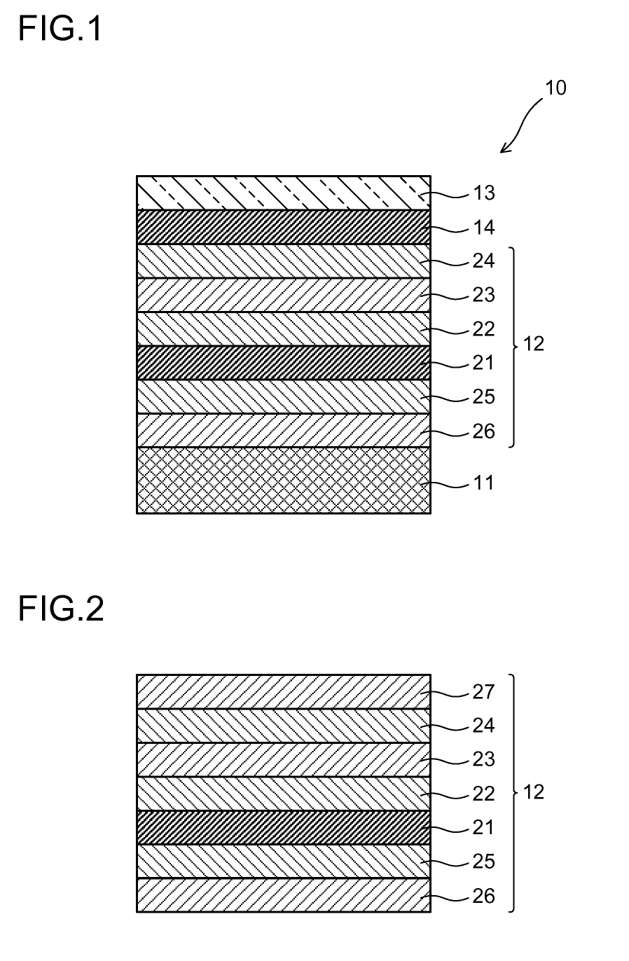

FIG. 1 is a sectional view showing an outline structure of a display device 10 according to one embodiment of the present invention. The display device 10 is composed of a display cell 11 with a polarizing plate 12 arranged at one face of the display cell 11. The display cell 11 can comprise a liquid crystal display (LCD) panel or an organic electroluminescence (OLED, organic light-emitting diode) display. An LCD or OLED has a plurality of pixels arrayed in a matrix, and achieves display by driving, i.e., turning on and off, the individual pixels with switching devices such as TFTs (thin-film transistors).

In a case where the display cell 11 is an LCD, the display cell 11 can be a liquid crystal cell composed of a liquid crystal layer held between a pair of substrates. On the side of the liquid crystal cell opposite from the polarizing plate 12, there are arranged another polarizing plate, which is arranged in a cross-Nicol relationship with the polarizing plate 12, and a backlight for illuminating the liquid crystal cell. These, however, are omitted from illustration in FIG. 1. In a case where the display cell 11 is an OLED display, it has a structure as described in detail later.

The display device 10 further has a front window 13 on the side of the polarizing plate 12 opposite from the display cell 11. The front window 13 serves as an exterior cover of the display device 10, and comprises, e.g., a cover glass. A gap between the front window 13 and the polarizing plate 12 is filled with a filler 14 comprising, e.g., an ultraviolet ray-curable resin. Without the filler 14, a layer of air would be formed between the front window 13 and the polarizing plate 12; light would then be reflected at the interfaces between the front window 13 and the layer of air and between the layer of air and the polarizing plate 12, possibly leading to degraded visibility of the displayed image. The filler 14 permits no layer of air to be formed between the front window 13 and the polarizing plate 12, and thus helps avoid degraded visibility of the displayed image resulting from light being reflected on those interfaces.

The polarizing plate 12 has a polarizer 21 that transmits predetermined linearly-polarized light. At one face of the polarizer 21 (opposite from the display cell 11), via an adhesive layer 22, there are stacked a quarter-wave film (λ/4 film) 23 and a curing layer 24 in this order, the latter comprising an ultraviolet ray-curable resin. At the other face of the polarizer 21 (facing the display cell 11), via an adhesive layer 25, a protective film 26 is bonded.

The polarizer 21 is produced, e.g., by dyeing a film of polyvinyl alcohol with a dichroic pigment and stretching it at a high factor. The polarizer 21 is subjected to alkali treatment (also called saponification), then has the quarter-wave film 23 bonded at one face via the adhesive layer 22, and then has the protective film 26 bonded at the other face via the adhesive layer 25.

Let the thickness of the polarizer 21 be B μm, then, from the perspective of making the polarizing plate 12 thin, it is preferable that

1 μm<B≦20 μm,

and it is more preferable that

1 μm<B≦15 μm.

The adhesive layers 22 and 25 are, e.g., layers of polyvinyl alcohol adhesive (PVA adhesive, water glue), but may instead be layers of ultraviolet ray-curable adhesive (UV adhesive). These adhesives are liquid when applied to bonding surfaces, and are later cured by drying or by irradiation with ultraviolet rays so that two objects are bonded together. That is, the adhesive layers 22 and 25, by their phase change from the liquid phase, bond together the polarizer 21 and the quarter-wave film 23, and bond together the polarizer 21 and the protective film 26. Thus, in that they bond together two objects by phase change from the liquid phase, the adhesive layers 22 and 25 differ from a sticking layer that bonds together two objects with no such phase change (a sheet-form sticking layer having a sticking agent on a base material).

In the embodiment, let the thickness of each of the adhesive layers 22 and 25 be A μm, then

0 μm<A≦5 μm.

Thus, with the adhesive layers 22 and 25, it is easy to make the polarizing plate 12 thinner than with an acrylic sticking agent (with a thickness of about 10 μm).

The quarter-wave film 23 constitutes a layer that gives the light transmitted through it a planar phase difference (retardation) of about one-quarter of its wavelength, and in this embodiment comprises a cellulose-based resin (cellulose-based polymer). The quarter-wave film 23 may comprise, instead of a cellulose-based polymer, a polycarbonate-based resin (polycarbonate-based polymer), or a cycloolefin-based resin (cycloolefin-based polymer). From the perspective of chemical resistance, it is preferable that the quarter-wave film 23 comprise a cellulose-based polymer or a polycarbonate-based polymer.

The quarter-wave film 23 is a thin-film quarter-wave film with a thickness of 10 to 70 μm. The angle (the intersection angle) between the slow axis of the quarter-wave film 23 and the absorption axis of the polarizer 21 is in the range from 30° to 60°. Thus, the linearly polarized light from the polarizer 21 is converted into circularly polarized light or elliptically polarized light by the quarter-wave film 23.

The curing layer 24 (also called hard-coat layer) is formed of an active energy ray-curable resin (e.g., an ultraviolet ray-curable resin), and serves to protect the surface of the polarizing plate 12. The curing layer 24 contains an organic compound that is capable of absorbing ultraviolet rays. One example of such an organic compound (organic UV absorber) is TINUVIN 928 (manufactured by BASF Japan Ltd.)

The protective film 26 is formed of an optical film comprising, e.g., acrylic resin, cyclic polyolefin (COP), or polycarbonate (PC). In a case where the display cell 11 is an LCD, the protective film 26 is provided simply as a film for protecting the reverse side of the polarizer 21, but may instead be provided as an optical film that simultaneously serves as a retardation film having a desired optical compensation capability.

In a case where the display cell 11 is an LCD, the other polarizing plate, i.e., the one arranged on the side of the display cell 11 (liquid crystal cell) opposite from the polarizing plate 12, is composed of a polarizer of which the surface is held between two optical films. Usable here as the polarizer and the optical films are those similar to the polarizer 21 and the protective film 26 of the polarizing plate 12.

In a case where the display cell 11 is an OLED display, it is preferable that the polarizing plate 12 serve as a circular polarizing plate (or elliptical polarizing plate) for preventing outside light reflection. Such a circular polarizing plate is preferably produced by using as the display cell 11 side protective film 26 of the polarizer 21 an optical film that gives the transmitted light a planar phase difference of about one-quarter of its wavelength, and bonding together the polarizer 21 and the protective film 26 via the adhesive layer 25 such that the absorption axis of the polarizer 21 and the slow axis of the protective film 26 intersect at an angle of about 45°.

In the polarizing plate 12 described above, owing to the quarter-wave film 23 being arranged further outside the polarizer 21 (closer to the viewer), linearly polarized light emanating from the display cell 11 and then transmitted through the polarizer 21 is converted into circularly or elliptically polarized light by the quarter-wave film 23. Accordingly, when a viewer wearing polarized sun glasses views the image displayed on the display device 10, irrespective of the angle from which he does so (irrespective of how the transmission axis of the polarized sun glasses is deviated from the transmission axis of the polarizer 21 (perpendicular to its absorption axis)), light components parallel to the transmission axis of the polarized sun glasses can be directed to the viewer's eyes to permit him to view the displayed image. Thus, it is possible to prevent the displayed image from becoming less visible depending on the viewing angle.

Moreover, in the embodiment, as described above, the curing layer 24 comprising an ultraviolet ray-curable resin contains an organic compound capable of absorbing ultraviolet rays. Thus, with respect to its thickness direction, the curing layer 24 cures more easily by absorbing more ultraviolet radiation the closer to its face at which it is irradiated with ultraviolet rays during curing (the UV-exposed face, i.e., the obverse face opposite from the quarter-wave film 23), and cures less easily the closer to its opposite face, i.e., the reverse face facing the quarter-wave film 23). Thus, the curing layer 24 is softer (has lower hardness) at the interface with the quarter-wave film 23 than at the obverse side.

Thus, even in a case where the polarizing plate 12 is produced by stacking the thin-film quarter-wave film 23 and the curing layer 24 on the polarizer 21 via the adhesive layer 22, the quarter-wave film 23 is exposed to less stress from the curing layer 24 side during a durability test. This helps suppress development of a crack in the quarter-wave film 23 during a durability test. Moreover, owing to the quarter-wave film 23 being firmly bonded to the polarizer 21 via the adhesive layer 22, even when the quarter-wave film 23 contracts as the polarizer 21 contracts during a durability test, the part of the curing layer 24 close to the interface with the quarter-wave film 23 (i.e., the part softer than at the obverse side) absorbs the contraction, and this helps maintain close contact between the curing layer 24 and the quarter-wave film 23.

Thus, with the thin-film polarizing plate 12 having the thin-film quarter-wave film 23 bonded to the polarizer 21 via the adhesive layer 22, it is possible to suppress cracks in the quarter-wave film 23 and exfoliation of the curing layer 24 during durability tests. As a result, even when the polarizing plate 12 described above is applied to the display device 10, it is possible to alleviate degradation in visibility, for a viewer wearing polarized sun glasses, of the displayed image resulting from cracks in the quarter-wave film 23 or exfoliation of the curing layer 24.

Here, the polarizer 21 and the quarter-wave film 23 described above may each be prepared in the form of a long film. In that case, it is preferable that the slow axis of the quarter-wave film 23 be inclined at an angle of 30° to 60° to the length direction of the quarter-wave film 23. It is then possible to produce the quarter-wave film 23 in the form of a rolled film by oblique stretching, which will be described later, and then bond the film to the polarizer 21 prepared in a rolled form, by a so-called roll-to-roll process, to produce the polarizing plate 12 in the form of a long film. This, compared with producing the polarizing plate 12 by a so-called batch process, whereby pieces of films are bonded together on a one-to-one basis, helps dramatically enhance productivity and greatly improve yields.

An adhesion enhancement layer for enhancing the adhesion of the quarter-wave film 23 may be provided on the adhesive layer 22 side of the quarter-wave film 23. The adhesion enhancement layer is formed by applying adhesion enhancement treatment to the adhesive layer 22 side face of the quarter-wave film 23. Examples of adhesion enhancement treatment include corona (discharge) treatment, plasma treatment, frame treatment, ITRO treatment, glow (discharge) treatment, ozone treatment, primer coating treatment, etc., of which one or more can be applied. Of these types of adhesion enhancement treatment, from the perspective of productivity, corona treatment and plasma treatment are preferred.

FIG. 2 is a sectional view showing another structure of the polarizing plate 12 applicable to the display device 10 according to the embodiment. In the polarizing plate 12, an overcoat layer 27 as a functional layer can be formed on the curing layer 24. The overcoat layer 27 is preferably formed as a hard-coat layer (curing layer) comprising an active energy ray-curable resin (e.g., ultraviolet ray-curable resin) like the curing layer 24, and can more preferably be formed as a hard-coat layer containing substantially no organic compound capable of absorbing ultraviolet rays or containing less (in percent by mass) of an organic compound capable of absorbing ultraviolet rays than the curing layer 24.

Providing the overcoat layer 27 on the curing layer 24 as described above helps protect the surface of the curing layer 24. Moreover, forming the overcoat layer 27 as a hard-coat layer permits the quarter-wave film 23 to have two hard-coat layers formed on one side. This helps reliably protect the surface of the polarizing plate 12. Furthermore, forming the overcoat layer 27 as a hard-coat layer containing substantially no organic compound capable of absorbing ultraviolet rays or containing less (in percent by mass) of an organic compound capable of absorbing ultraviolet rays than the curing layer 24 helps suppress elution of the organic compound capable of absorbing ultraviolet rays that is contained in the curing layer 24.

[Details on Each Layer of the Polarizing Plate]

<Polarizer>

The polarizer, which is the principal component of the polarizing plate, is a device that transmits only light having a polarization plane in a predetermined direction. One representative example of known polarizers is polyvinyl alcohol-based polarizing films. Polyvinyl alcohol-based polarizing films include polyvinyl alcohol-based films dyed with iodine and those dyed with a dichroic pigment.

Usable as the polarizer is one produced in the following manner: a water solution of polyvinyl alcohol is formed into film; then, the film is either stretched by uniaxial extension and then dyed, or dyed and then stretched by uniaxial extension; then, preferably, the film is subjected to durability treatment using a boron compound. The thickness of the polarizer is preferably from 1 to 30 μm, more preferably from 1 μm to 20 μm, still more preferably from 1 μm to 15 μm, and particularly preferably from 2 to 15 μm.

Also preferably used is ethylene-modified polyvinyl alcohol as disclosed in JP-A-2003-248123 and JP-A-2003-342322, containing 1 to 4% by mol of ethylene units and having a degree of polymerization of 2000 to 4000 and a degree of saponification of 99.0 to 99.99% by mol. Among others, ethylene-modified polyvinyl alcohol with a hot water cutting temperature of 66 to 73° C. A polarizer using such ethylene-modified polyvinyl alcohol has excellent polarization performance and durability, has few color spots, and is particularly preferred in large-screen liquid crystal display devices.

Instead, a coating-type polarizer may be produced by a method as disclosed in JP-A-2011-100161, JP-B-4691205, JP-B-4751481, and JP-B-4804589, the polarizer being then bonded to the quarter-wave film according to the embodiment.

<Quarter-Wave Film>

A quarter-wave film denotes a film that has a planar phase difference of approximately one-quarter of the wavelength of predetermined light (typically, in the range of visible light). To obtain substantially perfect circularly polarized light in the range of wavelengths of visible light, preferably, the quarter-wave film is a broad-spectrum quarter-wave film having a phase difference of largely one-quarter of wavelengths in the range of visible light.

Preferably, the quarter-wave film has a planar retardation value Ro (550) as measured at the wavelength of 550 nm in the range of 60 nm or more but 220 nm or less, more preferably in the range of 80 nm or more but 200 nm or less, and still more preferably in the range of 90 nm or more but 190 nm or less. A planar retardation value Ro is given by the formula below.

Ro=(nx−ny)×d

In the formula, nx represents the maximum refraction index within the film plane (also called the refraction index in the slow-axis direction), ny represents the refraction index in the direction perpendicular to the slow axis within the film plane, both as measured at 23° C. RH, at the wavelength of 550 nm; and d represents the thickness (nm) of the film.

Ro can be calculated on an automatic birefringence tester KOBRA-21ADH (manufactured by Oji Scientific Instruments), through birefringence measurement at respective wavelengths in an environment of 23° C., 55% RH.

For the quarter-wave film to function effectively as such, preferably, it simultaneously fulfills the relationship Ro(590)−Ro(450)≧2 nm, more preferably Ro(590)−Ro(450)≧5 nm, and still more preferably Ro(590)−Ro(450)≧10 nm.

Stacking together the quarter-wave film and a polarizer, which will be described later, such that the slow axis of the former and the transmission axis of the latter form an angle of substantially 45° yields a circular polarizing plate. An angle of substantially 45° covers angles in the range from 30° to 60°, and more preferably in the range from 40° to 50°. The angle between the slow axis of the quarter-wave film within the film plane and the transmission axis of the polarizer is preferably from 41 to 49°, more preferably from 42 to 48°, still more preferably from 43 to 47°, and particularly preferably from 44 to 46°.

The quarter-wave film can be formed of any optically transparent resin, examples including acrylic-based resin, polycarbonate-based resin, cycloolefin-based resin, polyester-based resin, polylactate-based resin, polyvinyl alcohol-based resin, and cellulose-based resin. Among these, from the perspective of chemical resistance, cellulose-based resin and polycarbonate-based resin are preferred as the material for the quarter-wave film; from the perspective of heat resistance, cellulose-based resin is preferred as the material for the quarter-wave film.

(Cellulose-Based Resin)

As cellulose-based resin (including cellulose ester-based resin), it is preferable to use a species containing cellulose acylate fulfilling formulae (i) and (ii) below.

2.0≦Z1<3.0 Formula (i)

0≦X Formula (ii)

In these formulae (i) and (ii), Z1 represents the total degree of substitution by acyl in cellulose acylate, and X represents the sum of the degree of substitution by propionyl and the degree of substitution by butyryl in cellulose acylate.

<Cellulose Acylate>

A cellulose acylate film usable in the embodiment contains cellulose acylate as a main component.

A cellulose acylate film usable in the embodiment contains, preferably, 60% to 100% by mass of cellulose acylate in the total mass, i.e., 100% by mass, of the film.

Examples of cellulose acylate include esters of cellulose with an aliphatic carboxylic acid and/or an aromatic carboxylic acid each with a carbon number of 2 to about 22, particularly preferred being esters of cellulose with a low fatty acid with a carbon number of 6 or less.

An acyl group bonded to a hydroxyl group in cellulose can be straight-chained or branched, can form a ring, and can be substituted by another substituent. For a given degree of substitution, the greater the carbon number mentioned above, the lower birefringence. Thus, it is preferable to select from acyl groups with carbon numbers of 2 to 6, and the sum of the degrees of substitution by propionyl group and by butyryl group is 0.5 or more. It is preferable that, in the form of cellulose acylate as mentioned above, the carbon number be in the range from 2 to 4, and more preferably in the range from 2 to 3.

Specifically, as cellulose acylate, it is possible to use an ester of cellulose with mixed fatty acids, such as cellulose acetate propionate, cellulose acetate butyrate, cellulose acetate propionate butyrate, and cellulose acetate phthalate, where not only an acetyl group but also a propionate group, butyrate group, or phtharyl group is bonded. A butyryl group forming butyrate can be straight-chained or branched.

In the embodiment, particularly preferably used as cellulose acylate is cellulose acetate, cellulose acetate butyrate, or cellulose acetate propionate.

It is preferable that the cellulose acylate according to the embodiment fulfill both formulae (iii) and (iv) below.

2.0≦X+Y<3.0 Formula (iii)

0≦X Formula (iv)

In these formulae, Y represents the degree of substitution by acetyl group, and X represents the degree of substitution by propionyl group, butyryl group, or a mixture thereof

To obtain desired optical properties, resins with different degrees of substitution may be mixed. In that case, it is preferable that the mix ratio be 1:99 to 99:1 (by mass).

Particularly preferred species of cellulose acylate among those mentioned above is cellulose acetate propionate. With cellulose acetate propionate, it is preferable that 0≦Y≦2.5 and in addition that 0.5≦X<3.0 (where 2.0≦X+Y<3.0), and it is more preferable that 0.5≦Y≦2.0 and in addition that 1.0≦X≦2.0 (where 2.0≦X+Y<3.0). The degree of substitution by acyl group can be measured in compliance with ASTM-D817-96.

There is no particular restriction on cellulose as a source material for cellulose acylate, examples including cotton linters, wood pulp, and kenaf. Cellulose acylate obtained from those can be mixed in arbitrary proportions.

Cellulose acylate can be produced by a well-known process. Specifically, it can be synthesized, for example, by a method based on what is disclosed in JP-A-H10-45804.

<Additives>

The quarter-wave film according to the embodiment is produced as an obliquely stretched film in the form of a long film by oblique stretching, which will be described later, and can contain, as necessary, any polymer component other than a cellulose ester. It is preferable that the mixed polymer component be compatible with a cellulose ester, and that, as an obliquely stretched film in the form of a long sheet, it have a transmittance of 80% or more, more preferably 90% or more, and particularly preferably 92% or more.

Examples of additives that can be added include a plasticizer, an ultraviolet ray absorber, a retardation adjuster, an antioxidant, a deterioration inhibitor, a release assistant, a surfactant, a dye, and fine particles. In the embodiment, an additive other than fine particles can be added during preparation of a cellulose ester solution, or can be added during preparation of a fine particle-dispersed liquid. It is preferable to add a plasticizer, an antioxidant, an ultraviolet ray absorber, etc. to a polarizing plate for use in a liquid crystal display device such as an organic EL display in order to give it heat resistance and moisture resistance.

It is preferable that the content of those compounds in a cellulose ester be 1 to 30% by mass, and more preferably 1 to 20% by mass. To suppress bleeding out etc. during stretching and drying, it is preferable that those compounds have a vapor pressure of 1400 Pa or less at 200° C.

Those compounds can be added along with a cellulose ester and a solvent during preparation of a cellulose ester solution, or can be added during or after preparation of the solution.

(Retardation Adjuster)

As a compound that is added to control retardation, it is possible to use an aromatic compound having two or more aromatic rings as disclosed in EP 911,656 A2.

It is also possible to use two or more species of aromatic compounds. It is particularly preferable that aromatic rings in such aromatic compounds include, in addition to an aromatic hydrocarbon ring, an aromatic hetero ring. In general, aromatic hetero rings are unsaturated hetero rings. Particularly preferred among them is a 1,3,5-triazine ring.

(Polymer or Oligomer)

In the embodiment, it is preferable that a cellulose ester film include a cellulose ester and a polymer or oligomer of a vinyl compound having a substituent selected from the group of carboxyl group, hydroxyl group, amino group, amide group, and sulfo group, and having a weight-average molecular weight in the range of 500 to 200,000. It is preferable that the content ratio by mass of the cellulose ester to the polymer or oligomer be in the range of 95:5 to 50:50.

(Matting Agent)

In the embodiment, as a matting agent, fine particles can be contained in a obliquely stretched long film. This makes the stretched film, in a case where it is a long film, easy to transport and wind up.

It is preferable that the matting agent be primary particles or secondary particles with a particle diameter of 10 nm to 0.1 μm. A preferred matting agent is approximately spherical primary particles with an ellipticity of 1.1 or less.

Preferred fine particles contain silicon, and particularly preferably silicon dioxide. Examples of fine particles of silicon dioxide preferred in the embodiment include those manufactured by Nippon Aerosil Co., Ltd. under the product names Aerosil R972, R972V, R974, R812, 200, 200V, 300, R202, OX50, and TT600 (manufactured by Nippon Aerosil Co., Ltd.). Preferred among these are Aerosil 200V, R972, R972V, R974, R202, and R812. Examples of polymer fine particles include particles of silicone resin, fluorine resin, and acrylic resin. Preferred is silicone resin, in particular species having a three-dimensional net-like structure. Examples of such resins include Tospearl 103, Tospearl 105, Tospearl 108, Tospearl 120, Tospearl 145, Tospearl 3120, and Tospearl 240 (manufactured by Toshiba Silicone Co., Ltd.).

(Other Additives)

It is possible to add inorganic fine particles, such as kaolin, talc, diatomaceous earth, quartz, calcium carbonate, barium sulfate, titanium oxide, or alumina, and a heat stabilizer, such as a salt of an alkaline-earth metal such as calcium or magnesium. It is possible to further add a surfactant, a release assistant, an antistat, a flame-retardant, a lubricant, an oily agent, etc.

A cellulose ester resin-based film usable in the embodiment can be formed by one of well-known processes, among which solution flow casting and melt flow casting are preferred. A process for film formation will be described later.

(Polycarbonate-Based Resin)

Any species of polycarbonate-based resin can be used with no particular restriction. From the perspectives of chemical and physical properties, aromatic polycarbonate resin is preferred, and bisphenol A-based polycarbonate resin is more preferred. Still more preferred are species using a bisphenol A derivative having a benzene ring, a cyclohexane ring, an aliphatic hydrocarbon group, etc. introduced in bisphenol A. Particularly preferred is polycarbonate resin obtained by using a bisphenol A derivative having those functional groups introduced asymmetrically with respect to the central carbon atom of bisphenol A and having a structure with reduced anisotropy within the unit molecule. Particularly preferred examples of such polycarbonate resin include species in which the two methyl groups of the central carbon atom of bisphenol A are substituted by benzene rings, or in which one hydrogen atom of each benzene ring of bisphenol A is replaced by a methyl group, phenyl group, or the like asymmetrically with respect to the central carbon atom.

Specifically, they are species obtained from a 4,4′-dihydroxydiphenyl arcane or a halogen substitution product thereof by a phosgene process or by an ester exchange process, examples including 4,4′-dihydroxydiphenyl methane, 4,4′-dihydroxydiphenyl ethane, and 4,4′-dihydroxydiphenyl butane. Other examples include polycarbonate-based resin disclosed in JP-A-2006-215465, JP-A-2006-91836, JP-A-2005-121813, JP-A-2003-167121, JP-A-2009-126128, JP-A-2012-31369, JP-A-2012-67300, WO 00/26705, etc.

Polycarbonate resin can be used in a form of a mixture with transparent resin such as polystyrene-based resin, methyl methacrylate-based resin, or cellulose acetate-based resin. A resin layer containing polycarbonate-based resin can be stacked on at least one face of a resin film formed by using cellulose acetate-based resin.

Preferred polycarbonate-based resin has a glass transition temperature (Tg) of 110° C. or higher and a water absorption coefficient of 0.3% or less (as measured in water at 23° C., for 24 hours). More preferred polycarbonate resin has a Tg of 120° C. or higher and a water absorption coefficient of 0.2% or less.

A polycarbonate-based resin film usable in the embodiment can be produced by one of well-known processes, among which solution flow casting and melt flow casting are preferred.

(Alicyclic Olefin Polymer-Based Resin)

Examples of alicyclic olefin polymer-based resin include cyclic olefin random multicomponent copolymers disclosed in JP-A-H05-310845, hydrogenated polymers disclosed in JP-A-H05-97978, and thermoplastic dicyclopentadiene open-ring polymers and hydrogenated products thereof disclosed in JP-A-H11-124429.

Alicyclic olefin polymer-based resin is a polymer having an alicyclic structure such as a saturated alicyclic hydrocarbon (cycloalkane) structure or an unsaturated alicyclic hydrocarbon (cycloalkene) structure. There is no particular restriction on the number of carbon atoms constituting the alicyclic structure; however, with the number of carbon atoms typically in the range of 4 to 30, preferably in the range of 5 to 20, and more preferably in the range of 5 to 15, an excellent balance of mechanical strength, heat resistance, and long film formability is suitably obtained.

The proportion of the repeating units containing the alicyclic structure in alicyclic olefin polymer resin is arbitrary, preferably 55% by weight or more, more preferably 70% by weight or more, and particularly preferably 90% by weight or more. With the proportion of the repeating units in those ranges, an optical material, such as a retardation film, obtained from an obliquely stretched long film according to the embodiment advantageously has enhanced transparency and heat resistance.

Examples of alicyclic olefin polymer-based resin include norbornene-based resin, monocyclic olefin-based resin, cyclic conjugated diene-based resin, vinyl alicyclic hydrocarbon-based resin, and hydrogenated products thereof. Among these, norbornene-based resin is suitably used for good transparency and formability.

Examples of norbornene-based resin include an open-ring polymer of a monomer having a norbornene structure, an open-ring copolymer of a monomer having a norbornene structure and another monomer, a hydrogenated product of those; and an addition polymer of a monomer having a norbornene structure, an addition copolymer of a monomer having a norbornene structure and another monomer, and a hydrogenated product of those or the like. Among these, an open-ring (co)polymer of a monomer having a norbornene structure is particularly suitably used from the viewpoints of transparency, formability, heat resistance, low hygroscopicity, dimensional stability, light weight, etc.

Preferred methods of forming a long film of norbornene-based resin as described above are solution flow casting and melt extrusion. Melt extrusion includes inflation using a die, and preferred from the viewpoints of productivity and excellent thickness accuracy is inflation using a T-die.

In extrusion using a T-die, by a process as disclosed in JP-A-2004-233604 for stably keeping thermoplastic resin in a melted state when brought into contact with a cooling drum, it is possible to produce a long film with satisfactorily small variation in optical properties such as retardation and orientation angle.

Specifically, examples of such processes include—(1) a process where, when a long film is produced by melt extrusion, thermoplastic resin in sheet form extruded from a die is drawn out in close contact with a cooling drum under a pressure of 50 kPa or less; (2) a process where, when a long film is produced by melt extrusion, the path from the die opening to the first-contact cooling drum is covered with a cover member, and the distance from the cover member to the die opening or to the first-contact cooling drum is controlled to be 100 mm or less; (3) a process where, when a long film is produced by melt extrusion, the temperature in the atmosphere within 10 mm or less of thermoplastic resin in sheet form extruded from the die opening is raised to a predetermined temperature; (4) thermoplastic resin in sheet form extruded from the die so as to fulfill a relationship is drawn out in close contact with a cooling drum under a pressure of 50 kPa or less; and (5) a process where, when a long film is produced by melt extrusion, thermoplastic resin in sheet form extruded from the die opening is blown with a wind the difference of the speed of which from the drawing speed of the first-contact cooling drum is 0.2 m/s or less.

The long film can be a single-layer film, or a stacked film having two or more layers. A stacked film can be obtained by a well-known process such as co-extrusion molding, co-flow casting, film lamination, or coating. Of these, co-extrusion molding and co-flow casting are preferred.

<Adhesive Layer>

The polarizer and the quarter-wave film can be bonded together by use of a water solution of fully saponified polyvinyl alcohol as adhesive (water glue), or by use of ultraviolet ray-curable adhesive. Ultraviolet ray-curable adhesive will now be described in detail.

Ultraviolet ray-curable adhesive is classified into a cationic polymerization type and a radical polymerization type. Preferred examples of ultraviolet ray-curable adhesive that can be suitably used in the embodiment contain an ultraviolet ray-curable adhesive composition containing the following components (α) to (δ):
(α) Cation-polymerizable compound
(β) Photocationic polymerization initiator
(γ) Photosensitizer exhibiting maxim absorption to light of wavelengths longer than 380 nm
(δ) Naphthalene-based auxiliary photosensitizer

(Cation-Polymerizable Compound (α))

The cation-polymerizable compound (α)), which is the main component of the ultraviolet ray-curable adhesive composition and which when cured by polymerization provides adhesion, can be any compound that cures by cationic polymerization, preferably containing at least two epoxy groups in the molecule. Epoxy compounds include, among others: aromatic epoxy compounds having an aromatic ring in the molecule; alicyclic epoxy compounds having at least two epoxy groups in the molecule of which one is bonded to an alicyclic ring; and aliphatic epoxy compounds having no aromatic ring in the molecule wherein an epoxy group and a ring (typically, an oxirane ring) including two carbon atoms to which it is bonded is bonded to another aliphatic carbon atom.

In an ultraviolet ray-curable adhesive composition used in the embodiment, particularly preferred as a cation-polymerizable compound is one containing, as a main component, epoxy resin containing no aromatic ring or an alicyclic epoxy compound. Using a cation-polymerizable compound containing an alicyclic epoxy compound as a main component yields a cured material with a high storage elastic modulus; in the polarizing plate having the quarter-wave film and the polarizer bonded together via the cured material (adhesive layer), the polarizer is less prone to break.

An alicyclic epoxy compound has at least two epoxy groups in the molecule, of which at least one is bonded to an alicyclic ring. Here, as expressed by general formula (ep) below, an epoxy group that is bonded to an alicyclic ring denotes one in which the two bonds of the epoxy group (—O—) are respectively directly bonded to two carbon atoms (typically, adjacent carbon atoms) in the alicyclic ring. In general formula (ep) below, m represents an integer of 2 to 5.

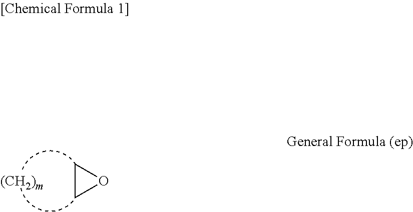

A compound in which one or more hydrogen atoms in (CH₂)ₘ in general formula (ep) is bonded to another chemical structure can be an alicyclic epoxy compound. A hydrogen atom in an alicyclic ring can be substituted by a straight-chain alkyl group such as a methyl group or ethyl group. Preferred compounds have an epoxycyclopentane ring (m=3 in the general formula (ep) above) or an epoxycyclohexane ring (m=4 in the general formula (ep) above).

An alicyclic epoxy compound can be used effectively in combination with epoxy resin having substantially no alicyclic epoxy group. Using a cation-polymerizable compound containing an alicyclic epoxy compound as a main component combined with epoxy resin having substantially no alicyclic epoxy group helps further enhance adhesion between the quarter-wave film and the polarizer while maintaining a high storage elastic modulus in the cured material.

Here, epoxy resin having substantially no alicyclic epoxy group is a compound having in the molecule an epoxy group and a ring (typically, an oxirane ring) including two carbon atoms to which it is bonded wherein one of the carbon atoms is bonded to another aliphatic carbon atom. Examples include polyglycidyl ethers of a polyhydric alcohol (phenol). For easy availability and a notable effect of enhancing close contact between the polarizer and the protective film, polyglycidyl ether compounds expressed by general formula (ge) below are preferred.

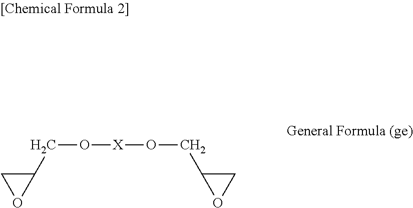

In the formula, X represents one of the following: a direct bond; a methylene group; an alkylidene with a number of carbon atoms from 1 to 4; an alicyclic hydrocarbon group; O, S, SO₂, SS, SO, CO, or OCO; and a substituent selected from the group of three substituents expressed by formulae (ge-1) to (ge-3) below. An alkylidene group may be substituted by a halogen.

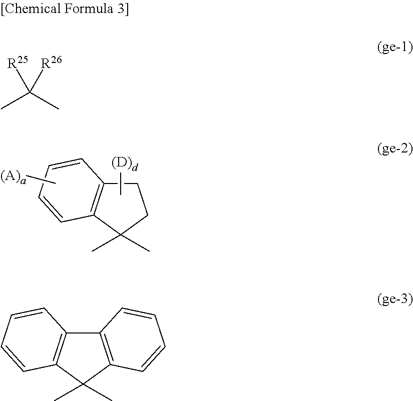

In formula (ge-1), R²⁵ and R²⁶ each independently represent one of the following: a hydrogen atom; an alkyl group with a number of carbon atoms from 1 to 3; a phenyl group that can be substituted by an alkyl group or alkoxy group with a number of carbon atoms from 1 to 10; and a cycloalkyl group with a number of carbon atoms from 3 to 10 that can be substituted by an alkyl group or alkoxy group with a number of carbon atoms from 1 to 10. R²⁵ and R²⁶ can be linked together to form a ring.

In formula (ge-2), A and D each independently represent one of the following: an alkyl group with a number of carbon atoms from 1 to 10 that can be substituted by a halogen atom; an aryl group with a number of carbon atoms from 6 to 20 that can be substituted by a halogen atom; an arylalkyl group with a number of carbon atoms from 7 to 20 that can be substituted by a halogen atom; a hetero ring group with a number of carbon atoms from 2 to 20 that can be substituted by a halogen atom; and a halogen. A methylene group in an alkyl, aryl, or arylalkyl group may be interrupted by an unsaturated bond, —O—, or —S—. The symbol “a” represents a number from 0 to 4, and the symbol “b” a number from 0 to 4.

Examples of diglycidyl ether compounds expressed by general formula (ge) include bisphenol-type epoxy resin such as a diglycidyl ether of bisphenol A, a diglycidyl ether of bisphenol F, and a diglycidyl ether of bisphenol S; polyfunctional epoxy resin such as a glycidyl ether of tetrahydroxy phenilmethane, a glycidyl ether of tetrahydroxy benzophenone, and epoxidized polyvinylphenol; a polyglycidyl ether of an aliphatic polyhydric alcohol; a polyglycidyl ether of an alkylene oxide adduct of an aliphatic polyhydric alcohol; and a diglycidyl ether of an alkylene glycol. Among these, a polyglycidyl ether of an aliphatic polyhydric alcohol is preferred for easy availability.

Examples of aliphatic polyhydric alcohols include those with carbon numbers in the range of 2 to 20. More specifically, they include aliphatic diols such as ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-heptanediol, 3,5-heptanediol, 1,8-octanediol, 2-methyl-1,8-octanediol, 1,9-nonanediol, and 1,10-decanediol; alicyclic diols such as cyclohexanedimethanol, cyclohexanediol, hydrogenated bisphenol A, and hydrogenated bisphenol F; and polyols with three or more hydroxyl groups such as trimethylolethane, trimethylolpropane, hexitols, pentitols, glycerine, polyglycerine, pentaerythritol, dipentaerythritol, tetramethylolpropane.

In a case where an alicyclic epoxy compound is used in combination with epoxy resin having substantially no alicyclic epoxy group, they are preferably blended in such a proportion that, of the total quantity of the cation-polymerizable compound, the alicyclic epoxy compound accounts for 50 to 95% by mass and the epoxy resin having substantially no alicyclic epoxy group accounts for 5% or more by mass. Blending the alicyclic epoxy compound to account for 50% or more by mass of the total quantity of the cation-polymerizable compound gives the cured material a storage elastic module of 1000 MPa or more at 80° C. Thus, in the polarizing plate having the polarizer and the quarter-wave film bonded together via the cured material (adhesive layer), the polarizer is less prone to break. On the other hand, blending the epoxy resin having substantially no alicyclic epoxy group to account for 5% or more by mass of the total quantity of the cation-polymerizable compound helps enhance close contact between the polarizer and the quarter-wave film. In a case where the cation-polymerizable compound is of a two-component type containing an alicyclic epoxy compound and epoxy resin having substantially no alicyclic epoxy group, the content of the latter is tolerated up to 50% by mass of the total quantity of the cation-polymerizable compound; this content, however, is preferably 45% or less by mass of the total quantity of the cation-polymerizable compound from the viewpoints of suppressing a drop in the storage elastic modulus of the cured material and preventing breakage of the polarizer.

In a case where, as the cation-polymerizable compound (α) contained in an ultraviolet ray-curable adhesive composition according to the embodiment, an alicyclic epoxy compound and epoxy resin having substantially no epoxy group are used in combination as described above, so long as their respective contents fall within the ranges mentioned above, another cation-polymerizable compound can be used in addition. Examples of such other cation-polymerizable compounds include epoxy compounds other than those expressed by general formulae (ep) and (ge) and oxetane compounds.

Epoxy compounds other than those expressed by general formulae (ep) and (ge) include alicyclic epoxy compounds other than those expressed by general formula (ep) and having an epoxy group bonded to at least one alicyclic ring in the molecule, aliphatic epoxy compounds other than those expressed by general formulae (ge) and having an oxirane ring bonded to an aliphatic carbon atom, aromatic epoxy compound having an aromatic ring and an epoxy group in the molecule, and hydrogenated epoxy compounds in which an aromatic ring in an aromatic epoxy compound is hydrogenated.

Examples of alicyclic epoxy compounds other than those expressed by general formula (ep) and having an epoxy group bonded to at least one alicyclic ring in the molecule include diepoxides of vinylcyclohexenes such as 4-vinylcyclohexenediepoxide and 1,2:8,9-diepoxylimonene.

Examples of aliphatic epoxy compounds other than those expressed by general formula (ge) and having an oxirane ring bonded to an aliphatic carbon atom include a triglycidyl ether of glycerin, a triglycidyl ether of trimethylolpropane, and a diglycidyl ether of polyethylene glycol.

An aromatic epoxy compound having an aromatic ring and an epoxy group in the molecule can be a glycidyl ether of an aromatic polyhydroxy compound having at least two phenolic hydroxy groups in the molecule, specific examples including a diglycidyl ether of bisphenol A, a diglycidyl ether of bisphenol F, a diglycidyl ether of bisphenol S, and a glycidyl ether of phenolnovolac resin.

A hydrogenated epoxy compound in which an aromatic ring in an aromatic epoxy compound is hydrogenated can be obtained by selectively hydrogenating, in the presence of a catalyst and under a pressure, an aromatic polyhydroxy compound having at least two phenolic hydroxy groups in the molecule as a source material of the aromatic epoxy compound, and then forming a glycidyl ether of the thus obtained hydrogenated polyhydroxy compound. Examples including a diglycidyl ether of hydrogenated bisphenol A, a diglycidyl ether of hydrogenated bisphenol F, and a diglycidyl ether of hydrogenated bisphenol S.

In a case where, out of epoxy compounds other than those expressed by general formulae (ep) and (ge), such a compound is blended as has an epoxy group bonded to an alicyclic ring and is classified into the alicyclic epoxy compounds defined previously, that compound is used such that the sum of it and an alicyclic epoxy compound expressed by general formula (ep) is 95% or less by mass of the total quantity of the cation-polymerizable compound.

An oxetane compound that can be an arbitrary cation-polymerizable compound is a compound having a four-membered-ring ether (an oxetanyl group) in the molecule. Specific examples include 3-ethyl-3-hydroxymethyl oxetane, 1,4-bis[(3-ethyl-3-oxetanyl)methoxymethyl]benzene, 3-ethyl-3-(phenoxymethyl)oxetane, di[(3-ethyl-3-oxetanyl)methyl]ether, bis[(3-ethyl-3-oxetanyl)methyl]ether, 3-ethyl-3-(2-ethylhexyloxymethyl)oxitane, 3-ethyl-3-(cyclohexyloxymethyl)oxetane, phenol novolac oxetane, 1,3-bis[(3-ethyloxetane-3-yl)methoxy]benzene, oxetanylsilsesquioxane, and oxetanyl silicate.

Blending 30% or less by mass of an oxetane compound in the total quantity of the cation-polymerizable compound can be expected to improve curability compared with using only an epoxy compound as the cation-polymerizable compound.

(Photocationic Polymerization Initiator (β)

In the embodiment, a cation-polymerizable compound as described above is cured by cationic polymerization through irradiation with active energy rays to form an adhesive layer; accordingly, it is preferable to blend a photocationic polymerization initiator (β) in the ultraviolet ray-curable adhesive composition.

When irradiated with active energy rays such as visible light rays, ultraviolet rays,

X-rays, or electron rays, a photocationic polymerization initiator generates a cation species or a Lewis acid and initiates polymerization of the cation-polymerizable compound (α). A photocationic polymerization initiator acts catalytically under light; thus, it offers excellent storage stability and workability even when blended in the cation-polymerizable compound (α). Examples of compounds that produce a cation species or a Lewis acid on irradiation with active energy rays include onium salts such as aromatic diazonium salts, aromatic iodonium salts, and aromatic sulfonium salts; and iron-arene complexes.

Examples of aromatic diazonium salts include benzenediazonium hexafluoroantimonate, benzenediazonium hexafluorophosphate, and benzenediazonium hexafluoroborate.

Examples of aromatic iodonium salts include diphenyliodonium tetrakis(pentafluorophenyl)borate, diphenyliodonium hexafluorophpsphate, diphenyliodonium hexafluoroantimonate, and di(4-nonylphenyl)iodonium hexafluorophpsphate.

Examples of aromatic sulfonium salts include triphenylsulfonium hexafluorophosphate, triphenylsulfonium hexafluoroantimonate, triphenylsulfonium tetrakis(pentafluorophenyl)borate, 4,4′-bis[diphenylsulfonio]diphenylfulfide bishexafluorophosphate, 4,4′-bis[di(β-hydroxyethoxy)phenylsulfonio]diphenylsulfide bishexafluoroantimonate, 4,4′-bis[di(β-hydroxyethoxy)phenylsulfonio]diphenylsulfide bishexafluorophosphate, 7-[di(p-tolyl)sulfonio]-2-isopropylthioxanthone hexafluoroantimonate, 7-[di(p-tolyl)sulfonio]-2-isopropylthioxanthone tetrakis(pentafluorophenyl)borate, 4-phenylcarbonyl-4′-diphenylsulphonio-diphenylsulfide hexafluorophosphate, 4-(p-tert-butylphenylcarbonyl)-4′-diphenylsulfonio-diphenylsulfide hexafluoroantimonate, 4-(p-tert-butylphenylcarbonyl)-4′-di(p-tolyl)sulfonio-diphenylsulfide tetrakis(pentafluorophenyl)borate.

Examples of iron-arene complexes include xylene-cyclopentadienyl iron(II) hexafluoroantimonate, cumene-cyclopentadienyl iron(II) hexafluorophosphate, xylene-cyclopentadienyl iron(II) tris(trifluoromethylsulfonyl)methanide.

These cation-polymerizable compounds can be used singly or in the form of a mixture of two or more of them. Particularly preferred among them are aromatic sulfonium salts because these absorb ultraviolet rays even in a wavelength region around 300 nm and thus provide excellent curability, yielding a cured material with satisfactory mechanical strength and adhesion strength.

One to ten parts by mass of the photocationic polymerization initiator (β) is blended in the total quantity, 100 parts, of the cation-polymerizable compound (α). Blending one part or more of an photocationic polymerization initiator in 100 parts of the cation-polymerizable compound (α) permits sufficient curing of the cation-polymerizable compound (α), giving the produced polarizing plate high mechanical strength and adhesion strength. On the other hand, an excess of a photocationic polymerization initiator leads to an increased amount of ionic substances in the cured material, giving the cured material higher hygroscopicity; this may degrade the durability of the polarizing plate. Hence, 10 parts or less by mass of the photocationic polymerization initiator (β) is blended in 100 parts by mass of the cation-polymerizable compound (α).

It is preferable that 2 parts or more but 6 parts or less by mass of the photocationic polymerization initiator (β) be blended in 100 parts by mass of the cation-polymerizable compound (α).

(Photosensitizer (γ))

An ultraviolet ray-curable adhesive composition according to the embodiment contains, in addition to a cation-polymerizable compound (α) containing an epoxy compound and a photocationic polymerization initiator (β) as described above, also a photosensitizer (γ) that exhibits maximum absorption to light of wavelengths longer than 380 nm. The photocationic polymerization initiator (β) described above exhibits maximum absorption to light of wavelengths about 300 nm or shorter, and is responsive to light of and around those wavelengths to produce a cation species or a Lewis acid, thereby to initiate cationic polymerization of the cation-polymerizable compound (α). To make it responsive also to light of wavelengths longer than 380 nm, a photosensitizer (γ) that exhibits maximum absorption to light of wavelengths longer than 380 nm is blended.

Suitably usable as such a photosensitizer (γ) are anthracene compounds expressed by general formula (at) below.

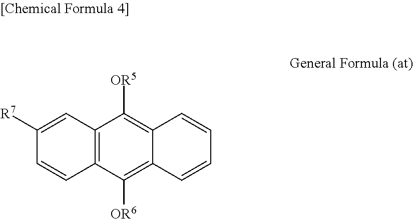

In the formula, R⁵ and R⁶ each independently represent an alkyl group with a carbon number of 1 to 6 or an alkoxyalkyl group with a carbon number of 2 to 12; R⁷ represents an alkyl group with a carbon number of 1 to 6.

Specific examples of anthracene compounds expressed by general formula (at) include 9,10-dimethoxyanthracene, 9,10-diethoxyanthracene, 9,10-dipropoxyanthracene, 9,10-diisopropoxyanthracene, 9,10-dibutoxyanthracene, 9,10-dipentyloxyanthracene, 9,10-dihexyloxyanthracene, 9,10-bis(2-methoxyethoxy)anthracene, 9,10-bis(2-ethoxyethoxy)anthracene, 9,10-bis(2-butoxyethoxy)anthracene, 9,10-bis(3-butoxypropoxy)anthracene, 2-methyl- or 2-ethyl-9,10-dimethoxyanthracene, 2-methyl- or 2-ethyl-9,10-diethoxyanthracene, 2-methyl- or 2-ethyl-9,10-dipropoxyanthracene, 2-methyl- or 2-ethyl-9,10-diisopropoxyanthracene, 2-methyl- or 2-ethyl-9,10-dibutoxyanthracene, 2-methyl- or 2-ethyl-9,10-dipentyloxyanthracene, and 2-methyl- or 2-ethyl-9,10-dihexyloxyanthracene,

Blending a photosensitizer (γ) as described above in the ultraviolet ray-curable adhesive composition, compared with blending no such additive, helps improve the curability of the ultraviolet ray-curable adhesive composition. Blending 0.1 parts or more by mass of the photosensitizer (γ) in 100 parts by mass of the cation-polymerizable compound (α) forming the ultraviolet ray-curable adhesive composition provides an effect of improving curability. On the other hand, to prevent precipitation during storage at low temperatures, two parts or less by mass of the photosensitizer (γ) is blended in 100 parts by mass of the cation-polymerizable compound (α). From the viewpoint of maintaining the neutral gray of the polarizer, so long as adequate adhesion is obtained between the polarizer and the protective film, it is advantageous to blend as little of the photosensitizer (γ) as possible. For example, it is preferable that 0.1 to 0.5 parts by mass, and more preferably 0.1 to 0.3% by mass, of the photosensitizer (γ) be blended in 100 parts by mass of the cation-polymerizable compound (α).

(Auxiliary Photosensitizer (δ))

An ultraviolet ray-curable adhesive composition according to the embodiment can contain, in addition to a cation-polymerizable compound (α) containing an epoxy compound, a photocationic polymerization initiator (β), and a photosensitizer (γ) as described above, also a naphthalene-based auxiliary photosensitizer (δ) that is expressed by general formula (nf) below.

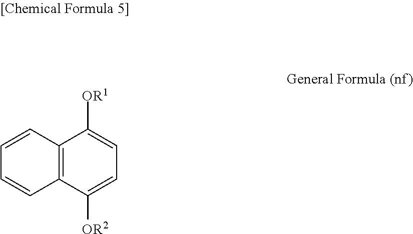

In the formula, R¹ and R² each represent an alkyl group with a carbon number of 1 to 6.

Examples of naphthalene-based auxiliary photosensitizers (δ) include 1,4-dimethoxynaphthalene, 1-ethoxy-4-methoxynaphthalene, 1,4-diethoxynaphthalene, 1,4-dipropoxynaphthalene, and 1,4-dibutoxynaphthalene.

Blending a naphthalene-based auxiliary photosensitizer (δ) in an ultraviolet ray-curable adhesive composition according to the embodiment, compared with blending no such additive, helps improve the curability of the ultraviolet ray-curable adhesive composition. Blending 0.1 parts or more by mass of the naphthalene-based auxiliary photosensitizer (δ) in 100 parts by mass of the cation-polymerizable compound (α) forming the ultraviolet ray-curable adhesive composition produces an effect of improving curability. On the other hand, to prevent precipitation during storage at low temperatures, 10 parts or less by mass of the naphthalene-based auxiliary photosensitizer (δ) is blended in 100 parts by mass of the cation-polymerizable compound (α). Preferably, 5 parts or less by mass of the naphthalene-based auxiliary photosensitizer (δ) is blended in 100 parts by mass of the cation-polymerizable compound (α).

So long as the effects of the embodiment are not spoilt, an ultraviolet ray-curable adhesive composition according to the embodiment can further contain any additive component as another optional component. Examples of additive components include, in addition to a photocationic polymerization initiator and a photosensitizer (γ) described above, a photosensitizer other than a photosensitizer (γ), a thermal cationic polymerization initiator, a polyol, an ion trapper, an antioxidant, a light stabilizer, a chain transfer agent, a tackifier, a thermoplastic resin, a bulking agent, a flow adjuster, a plasticizer, a defoamer, a leveler, a pigment, and an organic solvent.

Where an additive component is blended, it is preferable that 1000 parts or less by mass of the additive component be blended in 100 parts by mass of the cation-polymerizable compound (α). With 1000 parts or less by mass of such a component blended, the combination of the cation-polymerizable compound (α), the photocationic polymerization initiator (β), the photosensitizer (γ), and the naphthalene-based auxiliary photosensitizer (δ) as essential components of an ultraviolet ray-curable adhesive composition usable in the present invention can satisfactorily exert its effects of improving storage stability, preventing discoloration, improving curing speed, and achieving satisfactory adhesion.

<Hard-Coat Layer>

(Active Energy Ray-Curable Resin)

Preferably, a hard-coat layer used in the embodiment contains an active energy ray-curable resin that cures when irradiated with active energy rays such as ultraviolet rays.

An active energy ray-curable resin is a resin that cures by undergoing a cross-linking reaction when irradiated with active energy rays such as ultraviolet rays or electron rays. Active energy ray-curable resins are represented by ultraviolet ray-curable resins and electron ray-curable resins, and also include resins that cure when irradiated with active energy rays other than ultraviolet rays and electron rays.

Examples of ultraviolet ray-curable resins include ultraviolet ray-curable acrylic urethane-based resin, ultraviolet ray-curable polyester acrylate-based resin, ultraviolet ray-curable epoxy acrylate-based resin, ultraviolet ray-curable polyol acrylate-based resin, and ultraviolet ray-curable epoxy resin.

Generally, an ultraviolet ray-curable acrylic urethane-based resin can be easily obtained by reacting a polyester polyol with an isocyanate monomer or prepolymer and then reacting the product further with an acrylate-based monomer having a hydroxyl group such as 2-hydroxyethylacrylate, 2-hydroxyethylmethacrylate (hereinafter the term “acrylate” is assumed to cover “methacrylate”, and only compounds with “acrylate” will be enumerated) or 2-hydroxypropylacrylate. Suitably usable is, for example, a mixture of 100 parts of UNIDIC 17-806 (manufactured by DIC Corp.) and 1 part of CORONATE L (manufactured by Nippon Polyurethane Co., Ltd.), as mentioned in JP-A-559-151110.

Generally, an ultraviolet ray-curable polyester acrylate-based resin can be obtained easily by reacting a terminal hydroxyl or carboxyl group of polyester with a monomer of such as 2-hydroxyethyl acrylate, glycidyl acrylate, or acrylic acid (e.g., JP-A-559-151112).

An ultraviolet ray-curable epoxy acrylate-based resin can be obtained by reacting a terminal hydroxyl group of epoxy resin with a monomer of such as acrylic acid, acrylic acid chloride, or glycidyl acrylate.

Examples of ultraviolet ray-curable polyol acrylate-based resins include ethyleneglycol(meth)acrylate, polyethyleneglycol di(meth)acrylate, glycerin tri(meth)acrylate, trimethylolpropane triacrylate, pentaerythritol triacrylate, pentaerythritol tetraacrylate, dipentaerythritol pentacrylate, dipentaerythritol hexaacrylate, and alkyl-modified dipentaerythritol pentacrylate.

As examples of ultraviolet ray-curable epoxy acrylate-based resins and ultraviolet ray-curable epoxy resins, useful active energy ray-reactive epoxy compounds are enumerated below.

(a) Glycidyl ethers of bisphenol A (these compounds are obtained as mixtures with different degrees of polymerization through a reaction of epichlorohydrin with bisphenol A);

(b) Compounds having a terminal glycidyl ether group, obtained by reacting a compound having two phenolic OH's such as bisphenol A with epichlorohydrin, ethylene oxide and/or propylene oxide;

(c) Glycidyl ethers of 4,4′-methylene bisphenol;
(d) Epoxy compounds of phenol-formaldehyde resin such as novolac resin or resol resin;

(e) Compounds having an alicyclic epoxide, examples including bis(3,4-epoxycyclohexylmethyl)oxalate, bis(3,4-epoxycyclohexylmethyl)adipate, bis(3,4-epoxy-6-cyclohexylmethyl)adipate, bis(3,4-epoxycyclohexylmethyl pimelate) 3,4-epoxycyclohexylmethyl-3,4-epoxycyclohexane carboxylate, 3,4-epoxy-1-methylcyclohexylmethyl-3′,4′-epoxycyclohexane carboxylate, 3,4-epoxy-1-methyl-cyclohexylmethyl-3′,4′-epoxy-1-methylcyclohexane carboxylate, 3,4-epoxy-6-methyl-cyclohexylmethyl-3′,4′-epoxy-6′-methyl-1′-cyclohexane carboxylate, and 2-(3,4-epoxycyclohexyl-5,5′-spiro-3″,4″-epoxy)cyclohexane-meta-dioxane;

(f) Diglycidyl ethers of dibasic acids, examples including diglycidyl oxalate, diglycidyl adipate, diglycidyl tetrahydrophthalate, diglycidyl hexahydrophthalate, and diglycidyl phthalate;

(g) Diglycidyl ethers of glycols, examples including ethyleneglycol diglycidylether, diethyleneglycol diglycidylether, propyleneglycol diglycidylether, polyethyleneglycol diglycidylether, polypropyleneglycol diglycidylether, copoly(ethyleneglycol-propyleneglycol)diglycidylether, 1,4-butanediol diglycidylether, and 1,6-hexanediol diglycidylether;

(h) Glycidyl esters of polymer acids, examples including polyacrylic acid polyglycidylester and polyester diglycidylester;

(i) Glycidyl ethers of polyols, examples including glycerin triglycidylether, trimethylolpropane triglycidylether, pentaerythritol diglycidylether, pentaerythritol triglycidylether, pentaerythritol tetraglycidylether and glucose triglycidylether;

(j) Diglycidyl ethers of 2-fluoroalkyl-1,2-diols, examples including compounds similar to those enumerated above as examples of fluorine-containing epoxy compounds of fluororesins for the low refraction index substance described earlier;

and

(k) Glycidyl ethers of fluorine-containing terminal-alkane diols, examples including compounds similar to those enumerated above as examples of fluorine-containing epoxy compounds of fluororesins for the low refraction index substance described earlier.

The above epoxy compounds have molecular weights of 2000 or less, and preferably 1000 or less, on an average-molecular-weight basis.

When an epoxy compound as enumerated above is cured with active energy rays, for increased hardness, it is effective to mix a compound having a polyfunctional epoxy group belonging to (h) or (i) above.

A photopolymerization initiator or a photosensitizer for cationic polymerization of an epoxy-based active energy ray-reactive compound is a compound that can release a cationic polymerization initiating substance when irradiated with active energy rays, and is, particularly preferably, a group of double salts of onium salts that release a Lewis acid capable of initiating cationic polymerization when irradiated.

An active energy ray-reactive compound epoxy resin polymerizes not by radical polymerization but by cationic polymerization to form a cross-linked structure or a net-like structure; it is thus a preferred active energy ray-reactive resin because it is not affected by the oxygen in the reaction system as in radical polymerization.

An active energy ray-reactive epoxy resin useful in the embodiment is polymerized by a photopolymerization initiator or photosensitizer that releases a substance that initiates cationic polymerization when irradiated with active energy rays. Particularly preferred as a photopolymerization initiator is a group of double salts of onium salts that when irradiated with light release a Lewis acid that initiates cationic polymerization.

Representative are compounds expressed by general formula (a) below.

[(R¹)ₐ(R²)_{b}(R³)_{c}(R⁴)_{d}Z]^{W+}[MeX_{V}]^{W-} General Formula (a)

In the formula, the cation is an onium; Z represents one of S, Se, Te, P, As, Sb, Bi, O, a halogen (e.g., I, B, Cl), and N═N (diazo); and R¹, R², R³ and R⁴ each represent an organic group which may or may not be identical with any other. The symbols a, b, c, and d each represent an integer of 0 to 3, and a+b+c+d equals the valence of Z. Me represents a metal or metalloid which is the central atom of a halide complex, such as B, P, As, Sb, Fe, Sn, Bi, Al, Ca, In, Ti, Zn, Sc, V, Cr, Mn, or Co. X represents a halogen atom, w represents a net electric charge of the halide complex ion, and v represents the number of halogen atoms in the halide complex ion.

Specific examples of the anion [MeX_{V}]^{W-} in general formula (a) above include tetrafluoroborate (BF₄⁻), tetrafluorophosphoate (PF₄⁻), tetrafluoroantimonate (SbF₄⁻), tetrafluoroarsenate (AsF₄⁻), and tetrachloroantimonate (SbCl₄⁻).

Other examples of the anion include perchlorate ion (ClO₄⁻), trifluoromethylsulfite ion (CF₃SO₃⁻), fluorosulfonate ion (FSO₃⁻), toluene sulfonate ion, and trinitrobenzoate anion.

Among these onium salts, particularly effective as a cationic polymerization initiator are aromatic onium salts, particularly preferred examples including aromatic halonium salts described in JP-A-550-151996, JP-A-550-158680, etc.; group VIA aromatic onium salts described in JP-A-550-151997, JP-A-552-30899, JP-A-559-55420, JP-A-555-125105, etc.; oxosulfoxonium salts described in JP-A-556-8428, JP-A-556-149402, JP-A-557-192429, etc.; aromatic diazonium salts described in JP-A-S49-17040, etc.; and thiopyrylium salts described in U.S. Pat. No. 4,139,655 and the like. Other examples include aluminum complexes and photodegradable silicon compound-based polymerization initiators. A cation polymerization initiator as enumerated above can be used in combination with a photosensitizer such as benzophenone, benzoin isopropylether, or thioxanthone.

With an active energy ray-reactive compound having an epoxy acrylate group, it is possible to use a photosensitizer such as n-butyl amine, tryethylamine, or tri-n-butylphosphine. With respect to the photosensitizer or photopolymerization initiator used with the active energy ray-reactive compound, to initiate the photoreaction, it suffices to blend 0.1 to 15 parts by mass of it in 100 parts by mass of the ultraviolet ray-reactive compound, and preferably 1 to 10 parts by mass. The sensitizer is preferably one that exhibits maximum absorption in a near-ultraviolet to visible region of the spectrum.

In an active energy ray-curable resin composition useful in the embodiment, it is generally preferable that 0.1 to 15 parts by mass, and more preferably 1 to 10 parts by mass, of a polymerization initiator be blended in 100 parts by mass of an active energy ray-curable epoxy resin (prepolymer).

An epoxy resin can be used in combination with an urethane acrylate-type resin, a polyether acrylate-type resin, etc. as mentioned above, in which case it is preferable to use in combination an active energy-ray radical polymerization initiator and an active energy-ray cationic polymerization initiator.

In the hard-coat layer used in the embodiment, an oxetane compound can be used. The oxetane compound used can be a compound having an oxetane ring which is a three-member ring including oxygen or sulfur. Preferred are compounds having an oxetane ring including oxygen. The oxetane ring can be substituted by a halogen atom, haloalkyl group, arylalkyl group, alkoxyl group, allyloxy group, or acetoxy group. Specific examples include 3,3-bis(chloromethyl)oxetane, 3,3-bis(iodomethyl)oxetane, 3,3-bis(methoxymethyl)oxetane, 3,3-bis(phenoxymethyl)oxetane, 3-methyl-3-chloromethyloxetane, 3,3-bis(acetoxymethyl)oxetane, 3,3-bis(fluoromethyl)oxetane, 3,3-bis(bromomethyl)oxetane, and 3,3-dimethyloxetane. In the embodiment, any of a monomer, oligomer, and polymer can be used.

In the hard-coat layer used in the embodiment, the above-described active energy ray-curable resin can be mixed with any of well-known binders like a thermoplastic resin, a thermosetting resin, and a hydrophilic resin such as gelatin. These resins preferably have a polar group in the molecule. Examples of the polar group include —COOM, —OH, —NR₂, —NR₃X, —SO₃M, —OSO₃M, —PO₃M₂, —OPO₃M (where M represents a hydrogen atom, an alkali metal, or an ammonium group; X represents an acid constituting an amine salt; and R represents a hydrogen atom or an alkyl group).

In a case where the hard-coat layer used in the embodiment contains an active energy ray-curable resin, irradiation with active energy rays can be performed after a support member has been coated with an anti-glare hard-coat layer, an anti-reflection layer (a medium to high refraction index layer and a low refraction index layer), etc., and is preferably performed during the coating with the hard-coat layer.

The active energy rays used in the embodiment can be ultraviolet rays, electron rays, gamma rays, etc.; any source of energy that activates a compound can be used with no restriction. Preferred are ultraviolet rays and electron rays, and particularly preferred are ultraviolet rays because they are easy to handle and they readily provide high energy. As a light source of ultraviolet rays for photopolymerization of an ultraviolet ray-reactive compound, any light source that generates ultraviolet rays can be used. For example, it is possible to use a low-pressure mercury lamp, medium-pressure mercury lamp, high-pressure mercury lamp, ultrahigh-pressure mercury lamp, carbon arc lamp, metal halide lamp, xenon lamp, or the like. It is possible to use also light radiated from an ArF excimer laser, KrF excimer laser, excimer lamp, or synchrotron. While irradiation conditions vary from one type of lamp to another, a preferred amount of irradiation is 20 mJ/cm² or more, more preferably 50 to 10000 mJ/cm², and particularly preferably 50 to 2000 mJ/cm².

Irradiation with ultraviolet rays can be performed each time one of the hard-coat layer and the plurality of layers (a medium refraction index layer, a high refraction index layer, and a low refraction index layer) constituting the anti-reflection layer (described later) is formed, or after all these layers have been stacked, or in an eclectic manner. From the perspective of productivity, it is preferable to perform ultraviolet irradiation after a number of layers have been stacked.

Electron rays can be used likewise. Electron rays can be those with an energy of 50 to 1000 keV, and preferably 100 to 300 keV, emitted from any of various types of electron beam accelerator such as a Cockcroft-Walton type, a Van de Graaff type, a resonance transformer type, an insulated core transformer type, a linear type, a dynamitron type, and a high-frequency type.

Photopolymerization or photocross-linking of the active energy ray-reactive compound described above can be initiated with the active energy ray-reactive compound alone, but then polymerization may require a long introduction time or be slow to initiate. It is therefore preferable to use a photosensitizer or photopolymerization initiator, thereby to quicken polymerization.

In a case where the hard-coat layer used in the embodiment contains an active energy ray-curable resin, when it is irradiated with active energy rays, a photopolymerization initiator and a photosensitizer can be used.

Specific examples include acetophenone, benzophenone, hydroxybenzophenone, Michler's ketone, α-amyloxime ester, thioxanthone, and derivatives thereof. When a photoreactive agent is used in the synthesis of an epoxyacrlylate-based resin, a sensitizer such as n-butylamine, triethylamine, or tri-n-buthylphosphine can be used. The content of the photoreactive initiator and/or the photosensitizer in the ultraviolet ray-curable resin composition excluding the solvent component which volatilizes after application and drying is preferably 1 to 10% by mass, and particularly preferably 2.5 to 6% by mass of the composition.

In a case where an ultraviolet ray-curable resin is used as the active energy ray-curable resin, an ultraviolet ray absorber as mentioned below can be contained in the ultraviolet ray-curable resin composition to such an extent as not to suppress photocuring of the ultraviolet ray-curable resin.

To increase heat resistance of the hard-coat layer, an antioxidant which does not suppress the photocuring reaction can be selected and used. Examples include hindered phenol derivatives, thiopropionic acid derivatives, and phosphite derivatives. Specific examples include 4,4′-thiobis(6-tert-3-methylphenol), 4,4′-butylidene-bis(6-tert-butyl-3-methylphenol), 1,3,5-tris(3,5-di-tert-butyl-4-hydroxybenzyl)isocyanurate, 2,4,6-tris(3,5-di-tert-butyl-4-hydroxybenzyl)mesitylene, and di-octadecyl-4-hydroxy-3,5-di-tert-butylbenzylphosphate.

The ultraviolet ray-curable resin can be selected from, for example, ADEKAOPTOMER KR and BY series, i.e., KR-400, KR-410, KR-550, KR-566, KR-567, and BY-320B (manufactured by ADEKA Corp.); KOEIHARD A-101-KK, A-101-WS, C-302, C-401-N, C-501, M-101, M-102, T-102, D-102, NS-101, FT-102Q8, MAG-1-P20, AG-106, and M-101-C (manufactured by Koei Chemical Co. Ltd.); SEIKABEAM PHC2210(S), PHCX-9 (K-3), PHC2213, DP-10, DP-20, DP-30, P1000, P1100, P1200, P1300, P1400, P1500, P1600, and SCR900 (manufactured by Dainichiseika Color & Chemical Mfg. Co. Ltd.); KRM7033, KRM7039, KRM7130, KRM7131, UVECRYL 29201, and UVECRYL 29202 (manufactured by Daicel UCB Corp.); RC-5015, RC-5016, RC-5020, RC-5031, RC-5100, RC-5102, RC-5120, RC-5122, RC-5152, RC-5171, RC-5180, and RC-5181 (manufactured by DIC Corp.); OLEX No. 340 clear (manufactured by Chugoku Marine. Paints, Ltd.); SANRAD H-601 (manufactured by Sanyo Chemical Industries, Ltd.); SP-1509 and SP 1507 (manufactured by Showa Polymer Corp.); RCC-15C (manufactured by Grace Japan Corp.); ARONIX M-6100, M-8030, and M-8060 (manufactured by TOAGOSEI Co., Ltd.); and any other commercially available products.

It is preferable that the coating composition containing the active energy ray-curable resin have a solid component concentration of 10 to 95% by mass, and a suitable concentration is selected according to the method of application.

It is preferable that the hard-coat layer and the anti-reflection layer used in the embodiment contain also a surfactant, and preferable as such a surfactant is a silicone-based surfactant or a fluorosurfactant.

A preferred silicone-based surfactant is a non-ionic surfactant that has dimethylpolysiloxane as a hydrophobic group and polyoxyalkylene as a hydrophilic group.

Non-ionic surfactants refer collectively to surfactants that have no group which dissociates into ions in an aqueous solution and that have in addition to a hydrophobic group a hydrophilic group as exemplified by hydroxyl groups of a polyol or a polyoxyalkylene chain (polyoxyehylene). They have stronger hydrophilicity the larger the number of alcoholic hydroxyl groups is or the longer the polyoxyalkylene chain (polyoxyethylene chain) is.

It is preferable that a non-ionic surfactant according to the embodiment have dimethylpolysiloxane as a hydrophobic group. By use of a non-ionic surfactant having dimethylpolysiloxane as a hydrophobic group and polyoxyalkylene as a hydrophilic group, it is possible to improve unevenness in the anti-glare hard-coat layer and the low refraction index layer, and to improve the antifouling property of the film surfaces. This is considered to result from hydrophobic groups of polymethylsiloxane are oriented to the surface to form a film surface that is less prone to be soiled. This is an effect that cannot be obtained with other surfactants.

Specific examples of such non-ionic surfactants include, silicone surfactants SILWET L-77, L-720, L-7001, L-7002, L-7604, Y-7006, FZ-2101, FZ-2104, FZ-2105, FZ-2110, FZ-2118, FZ-2120, FZ-2122, FZ-2123, FZ-2130, FZ-2154, FZ-2161, FZ-2162, FZ-2163, FZ-2164, FZ-2166, and FZ-2191 manufactured by Nippon Unicar Co., Ltd.

Other examples include SUPERSILWET SS-2801, SS-2802, SS-2803, SS-2804, and SS-2805.

A preferred structure of such non-ionic surfactants having dimethylpolysiloxane as a hydrophobic group and polyoxyalkylene as a hydrophilic group is a straight-chain block copolymer in which dimethylpolysiloxane structure portions and polyoxyalkylene chains occur alternately and are linked together. Their superiority stems from a long principal chain skeleton and a straight-chain structure. It is considered that, with a block copolymer having alternately occurring hydrophilic groups and hydrophobic groups, individual surfactant molecules adsorb the surface of fine particles of silica at a plurality of places so as to cover it.

Specific examples of such surfactants include, silicone surfactants ABN SILWET FZ-2203, FZ-2207, and FZ-2208 manufactured by Nippon Unicar Co., Ltd.

Usable as a fluorosurfactant are surfactants in which the hydrophobic group has a perfluorocarbon chain. Corresponding species include fluoroalkyl carboxylic acid, disodium N-perfluorooctane sulfonyl glutaminate, sodium 3-(fluoroalkyloxy)-1-alkylsulfate, sodium 3-(ω-fluoroalkanoyl-N-ethylamino)-1-propanesulfonate, N-(3-perfluorooctane sulfoneamide) propyl-N,N-dimethyl-N-carboxymethylene ammoniumbetaine, perfluoroalkyl carboxylic acid, perfluorooctane sulfonic acid diethanolamide, perfluoroalkylsulfonate, N-propyl-N-(2-hydroxyethyl)perfluorooctane sulfoneamide, perfluoroalkylsulfoneamide propyltrimethyl ammonium salt, perfluoroalkyl-N-ethylsulfonyl glycin salt, and bis(N-perfluorooctylsulfonyl-N-ethylaminoethyl)phosphate. In the embodiment, a non-ionic surfactant is preferable.

Such fluorosurfactants are commercially available under the product names MEGAFAC, EFTOP, SURFLON, FTERGENT, UNIDYNE, FLUORAD, ZONYL, etc.

A preferred amount added is 0.01% to 3.0%, and more preferably 0.02% to 1.0%, of the solid component in the coating liquid for the hard-coat layer and the anti-reflection layer.

Another surfactant can be used in combination. For example, it is possible to use together, as necessary, an anionic surfactant such as a sulfonate-based, sulfate ester-based, or phosphate ester-based surfactant, or a non-ionic surfactant such as an ether-type or ether ester-type surfactant having polyoxyethylene as a hydrophilic group.

Usable as a solvent for application of the hard-coat layer is, for example, one or a mixture of more than one appropriately selected from hydrocarbons, alcohols, ketones, esters, glycolethers, and other solvents. Preferably used is a solvent containing 5% by mass or more of propyleneglycol mono(C1-C4)alkylether or propyleneglycol mono (C1-C4)alkyletherester, and more preferably 5 to 80% by mass or more.

The coating liquid of the hard-coat layer composition is applied by any of well-known methods such as gravure coating, spinner coating, wire bar coating, roll coating, reverse coating, extrusion coating, air doctor coating, spray coating, and ink-jetting. A preferred amount applied is 5 μm to 30 μm in wet film thickness, and preferably 10 μm to 20 μm. A preferred speed of application is 10 m/min to 200 m/min.

After application and drying, the hard-coat layer composition is preferably cured by being irradiated with active energy rays such as ultraviolet rays or electron rays. A preferred time of irradiation with active energy rays is 0.5 seconds to 5 minutes, and more preferably 3 seconds to 2 minutes from the viewpoints of curing efficiency of the ultraviolet ray-curable resin, work efficiency, etc.

Preferably, the hard-coat layer according to the embodiment is configured as described below.

The hard-coat layer as a curing layer contains an active energy ray-curable isocyanurate derivative and an active energy ray-curable resin selected from Group A, which will be described later. The content ratio of the active energy ray-curable isocyanurate derivative to the active energy ray-curable resin selected from Group A ((active energy ray-curable isocyanurate derivative): (Group A active energy ray-curable resin)) is 6.0:1.0 to 1.0:2.0.

In the following description, active energy ray-curable resins in general, including active energy ray-curable isocyanurate derivatives and Group A active energy ray-curable resins, are collectively referred to simply as an active energy ray-curable resin.

Active energy ray-curable resins are resins that cure through a cross-linking reaction or the like when irradiated with active energy rays such as ultraviolet rays or electron rays, and specifically are resins having an ethylene-type unsaturated group. Examples of ethylene-type unsaturated groups include vinyl group, vinylether group, (meth)acryloyl group, and (meth)acrylamide group. Among these, (meth)acryloyl group is preferred for ease of production.

(Active Energy Ray-Curable Isocyanurate Derivative)

An active energy ray-curable isocyanurate derivative can be a compound with a structure in which one or more ethylene-type unsaturated groups are bonded to an isocyanuric acid skeleton, and there is no further restriction in particular. Preferred are compounds that have three or more ethylene-type unsaturated groups and one or more isocyanurate ring within the same molecule as expressed by general formula (a) below. Examples of ethylene-type unsaturated groups include acryloyl group, methacryloyl group, styryl group, and vinylether group. Among these, methacryloyl group and acryloyl group are preferred, and acryloyl group is more preferred.

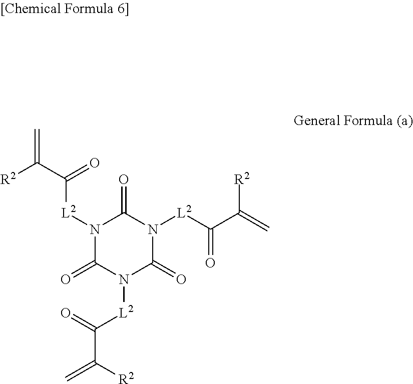

In the formula, L² represents a divalent linking group, which is preferably a substituted or unsubstituted alkyleneoxy group or polyalkyleneoxy group with a carbon atom number of 4 or less of which a carbon atom is bonded to an isocyanurate ring, and particularly preferably such an alkyleneoxy group. Each L² may or may not be identical with another. R² represents a hydrogen atom or a methyl group, and each R² may or may not be identical with another.

Specific compounds expressed by general formula (a) can be, but not limited to, as follows:

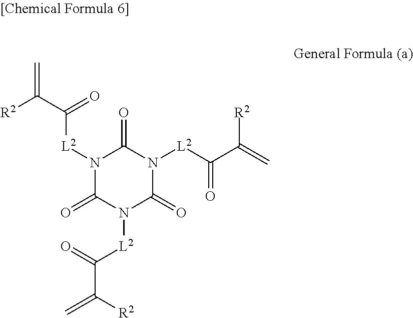

Examples of other compounds include isocyanurate diacrylate compounds. Preferred is isocyanurate ethoxy-modified diacrylate expressed by general formula (b) below.

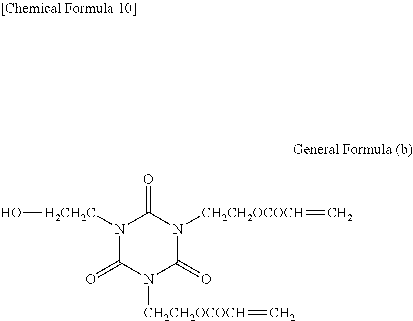

Examples of other compounds include ε-caprolactone-modified active energy ray-curable isocyanurate derivatives, which are specifically compounds expressed by general formula (c) below.

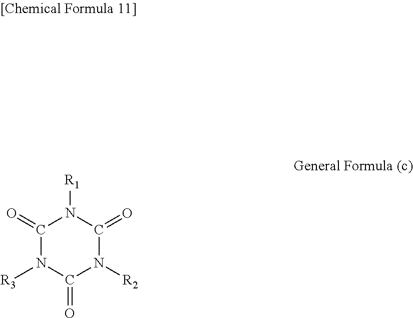

In the formula, R₁ to R₃ each represent one of the functional groups defined under a, b, and c below. At least one of R₁ to R₃ is a functional group defined under b.
a: —H or —(CH₂)ₙ—OH (where n=1 to 10, preferably n=2 to 6)
b: —(CH₂)ₙ—O—(COC₅H₁₀)ₘ—COCH═CH₂ (where n=1 to 10, preferably n=2 to 6; m=2 to 8)
c: —(CH₂)ₙ—O—R (where R represents a (meth)acryloyl group, n=1 to 10, preferably n=2 to 6)

Specific compounds expressed by general formula (c) can be, but not limited to, as follows:

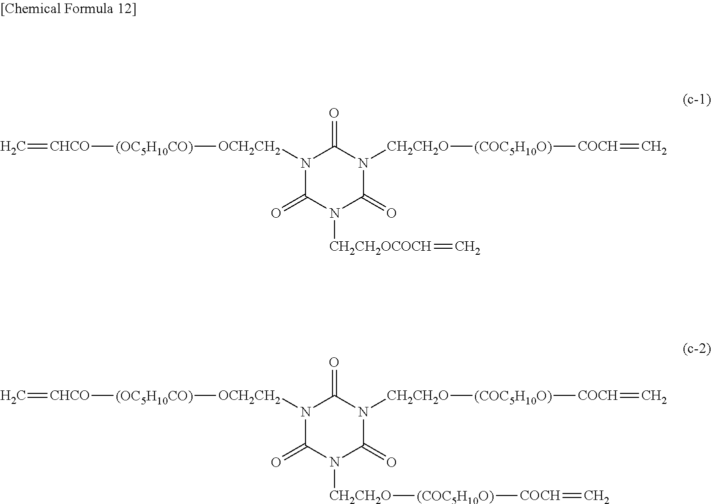

An example of a commercially available product of an isocyanurate triacrylate compound is A-9300 manufactured by Shin-Nakamura Chemical Co., Ltd. An example of a commercially available product of an isocyanurate diacrylate compound is ARONIX M-215 manufactured by Toa Gosei Co., Ltd. Examples of mixtures of an isocyanurate triacrylate compound and an isocyanurate diacrylate compound include ARONIX M-315 and ARONIX-313 manufactured by Toa Gosei Co., Ltd.

An example of an ε-caprolactone-modified active energy ray-curable isocyanurate derivative is ε-caprolactone-modified tris(acryloxyethyl) isocyanurate, available as, but not limited to, A-9300-1CL manufactured by Shin-Nakamura Chemical Co., Ltd. and ARONIX M-327 manufactured by Toa Gosei Co., Ltd.

(Group A Active Energy Ray-Curable Resins)

Active energy ray-curable resins classified into Group A includes resins defined under A1 to A3 below.

A1: Active energy ray-curable resins having an imide group

A2: Active energy ray-curable resins having an ethylene oxide skeleton

A3: Active energy ray-curable resins having a propylene oxide skeleton

(A1: Active Energy Ray-Curable Resins Having an Imide Group)

Examples of imide groups include cyclic imide groups expressed by general formula (d) below.

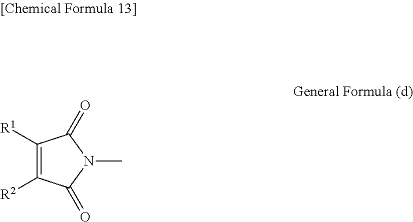

In general formula (d), either R¹ and R² each independently represent one of a hydrogen atom, halogen atom, alkyl group, or aryl group, or R¹ and R² together represent a hydrocarbon group forming a five- or six-membered ring.

Preferred as the alkyl group are those with a carbon number of 4 or less. Preferred as the alkenyl group are those with a carbon number of 4 or less. An example of the aryl group is a phenyl group. Examples of the hydrocarbon that forms a five- or six-membered ring include —CH₂CH₂CH₂—, —CH₂CH₂CH₂CH₂—, and unsaturated hydrocarbons such as —CH═CHCH₂— and —CH₂CH═CHCH₂—.

Specific examples further include cyclic imide groups expressed by formulae (d-1) to (d-6) below. In formula (d-5), X represents a chlorine atom or bromine atom. In formula (6), Ph represents a phenyl group.

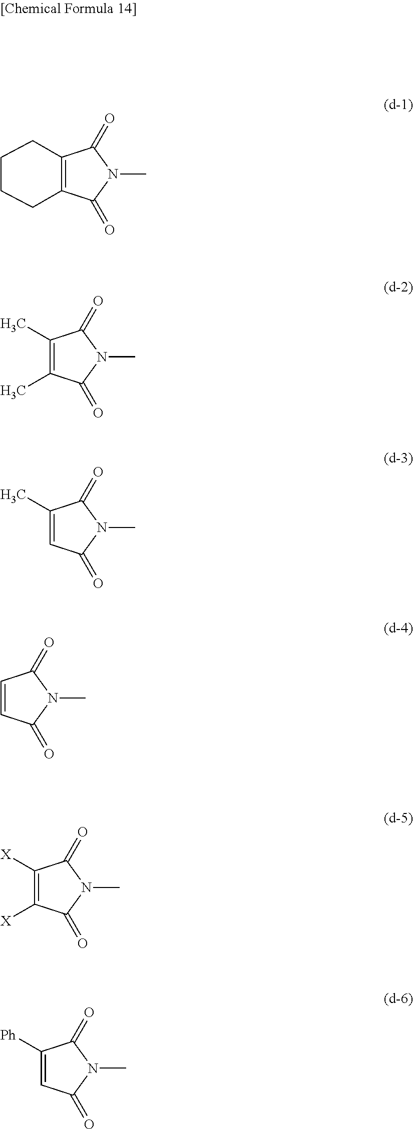

In formula (d-5), preferably, of the two X's, one is a hydrogen atom and the other is an alkyl group with a carbon number of 4 or less; or each is an alkyl group with a carbon number of 4 or less; or the two together constitute a saturated hydrocarbon group that forms a carbon ring.

Examples of active energy ray-curable resins having a cyclic imide group include maleimide acrylate expressed by general formula (A1-1) below.

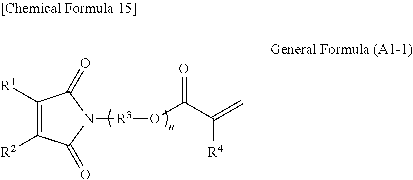

In general formula (A1-1), R¹ and R² represent the same chemical species as in general formula (d) above. R³ represents a straight-chain or branched alkylene group with a carbon number of 1 to 6, R⁴ represents a methyl group, and n represents an integer of 1 to 6.

Examples of compounds expressed by general formula (A1-1) include, but are not limited to, specific compounds expressed by general formulae (A1-11) to (A1-13) below.

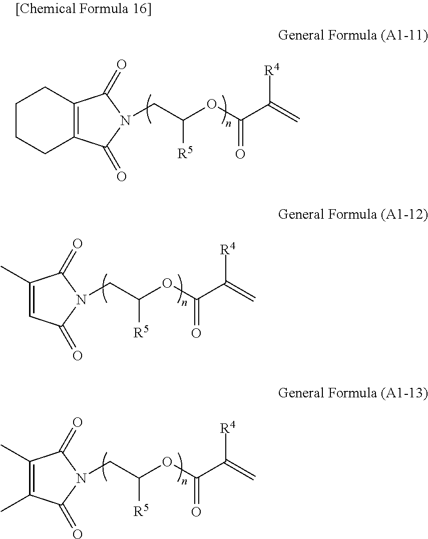

In general formulae (A1-11) to (A1-13), R⁴ and R⁵ each represent a hydrogen atom or a methyl group, and n represents an integer of 1 to 6.

A commercially available example of a compound expressed by general formula (A1-1) is ARONIX M-145 manufactured by Toa Gosei Co., Ltd. Examples of active energy ray-curable resins having a phthalimide group or the like include acryloyloxyethyl hexahydrophthalimide, of which a commercially available example is ARONIX M-140 manufactured by Toa Gosei Co., Ltd. Such active energy ray-curable resins having an imide group can be polymer compounds.

(A2: Active Energy Ray-Curable Resins Having an Ethylene oxide Skeleton)

(A3: Active Energy Ray-Curable Resins Having a Propylene oxide Skeleton) Examples of active energy ray-curable resins having an ethylene oxide skeleton or propylene oxide skeleton include ethylene oxide adducts or propylene oxide adducts of (or ethylene oxide-modified or propylene oxide-modified)(meth)acrylate.

Specific examples include, but are not limited to, ethylene oxide-modified grycerol triacrylate, ethylene oxide-modified trimethylolpropane acrylate, ethylene oxide-modified pentaerythritol tetraacrylate, propylene oxide-modified glycerol acrylate, propylene oxide-modified trimethylolpropane acrylate, and propylene oxide-modified pentaerythritol tetraacrylate. Other examples include, but are not limited to, (meth)acrylate having an ethylene oxide skeleton or propylene oxide skeleton in the principal skeleton of acrylate, such as polyethyleneglycol diacrilate, polypropyleneglycol diacrylate, tripropyleneglycol diacrilate, and dipropyleneglycol diacrylate.

Commercially available products include resins manufactured by Shin-Nakamura Chemical Co., Ltd., Toa Gosei Co., Ltd., etc. Specific examples include ethylene oxide-modified pentaerythritol tetraacrylate (under the product name NK Esther ATM-4E, manufactured by Shin-Nakamura Chemical Co., Ltd.), polyethyleneglycol #200 diacrylate (under the product name NK Ester A-200, manufactured by Shin-Nakamura Chemical Co., Ltd.), polyethyleneglycol #600 diacrylate (under the product name NK Ester A-600, manufactured by Shin-Nakamura Chemical Co., Ltd.), and polypropyleneglycol (#700) diacrylate (under the product name NK Ester AOG-700, manufactured by Shin-Nakamura Chemical Co., Ltd.).

Preferred as the Group A active energy ray-curable resin is an active energy ray-curable resin having an imide group, because it offers excellent pencil hardness.

By using an active energy ray-curable isocyanurate derivative and a Group A active energy ray-curable resin as described above in the hard-coat layer, and controlling the content ratio of those resins in such a range that (active energy ray-curable isocyanurate derivative): (Group A active energy ray-curable resin)=6.0:1.0 to 1.0:2.0, it is possible to obtain excellent interlayer adhesion and flexibility even in a sever environment. In the embodiment, in addition to the active energy ray-curable isocyanurate derivative and a Group A active energy ray-curable resin, another resin as a third component can be used in combination.

Examples of the third component other than an active energy ray-curable resin isocyanurate derivative and a Group A active energy ray-curable resin include ultraviolet ray-curable urethane acrylate-based resin, ultraviolet ray-curable polyester acrylate-based resin, ultraviolet ray-curable epoxy acrylate-based resin, ultraviolet ray-curable polyol acrylate-based resin, and ultraviolet ray-curable epoxy resin. Among these, ultraviolet ray-curable acrylate-based resins are preferred.

A preferred ultraviolet ray-curable acrylate-based resin is a polyfunctional acrylate. A polyfunctional acrylate is preferably selected from the group consisting of pentaerythritol polyfunctional acrylate, dipentaerythritol polyfunctional acrylate, pentaerythritol polyfunctional methacrylate, and dipentaerythritol polyfunctional methacrylate. Here, a polyfunctional acrylate is a compound having two or more acryloyloxy groups or methacryloyloxy groups in the molecule.

Preferred examples of monomers of polyfunctional acrylates include 1,6-hexanediol diacrylate, neopentylglycol diacrylate, trimethylolpropane triacrylate, pentaerythritol diacrylate, pentaerythritol triacrylate, pentaerythritol tetraacrylate, glycerine triacrylate, dipentaerythritol triacrylate, dipentaerythritol tetracrylate, dipentaerythritol pentacrylate, and dipentaerythritol hexacrylate.

Monofunctional acrylates can also be used. Examples of monofunctional acrylates include isobornyl acrylate, 2-hydroxy-3-phenoxypropyl acrylate, isostearyl acrylate, benzyl acrylate, ethyl carbitol acrylate, phenoxyethyl acrylate, lauryl acrylate, isooctyl acrylate, tetrahydrofurfuryl acrylate, behenyl acrylate, 4-hydroxybutyl acrylate, 2-hydroxyethyl acrylate, 2-hydroxypropyl acrylate, and cyclohexyl acrylate.

Monofunctional acrylates are available from Shin-Nakamura Chemical Co., Ltd. and Osaka Organic Chemical Industry Ltd. These compounds can be used singly or in the form of a mixture of two or more of them. Oligomers, such as dimers and trimers, of the monomers enumerated above can also be used.

It is preferable that an active energy ray-curable resin have a viscosity of 3000 mPa·s or less, and more preferably 2000 mPa·s or less, at 25° C. from the perspectives of coating properties and of controlling the later-described arithmetic mean coarseness Ra. Viscosity values are those measured on a B-type viscometer at 25° C.

It is preferable that the hard-coat layer contain a photopolymerization initiator for promotion of the polymerization of an active energy ray-curable resin. The content of the polymerization initiator is preferably in such a range that the ratio by mass (photopolymerization initiator):(active energy ray-curable resin)=20:100 to 0.01:100.

Specific examples of polymerization initiators include, but are not limited to, acetophenone, benzophenone, hydroxybenzophenone, Michler's ketone, a-amyloxime ester, thioxanthone, and derivatives of those.

For improved coating properties, a functional layer, such as the hard-coat layer and the overcoat layer, can contain a surfactant such as a silicone-based surfactant, a fluorine-based surfactant, or a non-ionic surfactant; or a fluorine-siloxane graft polymer.

Examples of non-ionic surfactants include the following products manufactured by Kao Corporation: EMULGEN 102KG, EMULGEN 103, EMULGEN 104P, EMULGEN 105, EMULGEN 106, EMULGEN 108, EMULGEN 109P, EMULGEN 120, EMULGEN 123P, EMULGEN 147, EMULGEN 210P, EMULGEN 220, EMULGEN 306P, EMULGEN 320P, EMULGEN 404, EMULGEN 408, EMULGEN 409PV, EMULGEN 420, EMULGEN 430, EMULGEN 705, EMULGEN 707, EMULGEN 709, EMULGEN 1108, EMULGEN 1118S-70, EMULGEN 1135S-70, EMULGEN 2020G-HA, EMULGEN 2025G, EMULGEN LS-106, EMULGEN LS-110, and EMULGEN LS-114. Examples of silicone-based surfactants include the following products manufactured by Shin-Etsu Chemical Co., Ltd.: X-22-4272, X-22-6266, KF-351, KF-352, KF-353, KF-354L, KF-355A, KF-615A, KF-945, KF-618, KF-6011, KF-6015, and KF-6004; and the following products manufactured by BYK-Chemie GmbH: BYK-300, BYK-302, BYK-306, BYK-307, BYK-310, BYK-313, BYK-315, BYK-320, BYK-322, BYK-323, BYK-325, BYK-330, BYK-331, BYK-333, BYK-342, BYK-345/346, BYK-347, BYK-348, BYK-349, BYK-370, BYK-377, BYK-378, BYK-3455, BYK-UV3510, BYK-UV3500, BYK-UV3530, and BYK-UV3570.

A fluorine-siloxane graft polymer is a copolymer obtained by grafting polysiloxane and/or organopolysiloxane including siloxane and/or organosiloxane themselves to at least a fluorine-based resin. Commercially available examples of fluorine-siloxane graft polymers include the following products manufactured by Fuji Kasei Kogyo Co., Ltd.: ZX-022H, ZX-007C, ZX-049, and ZX-047-D. This component is preferably blended such that its content in the solid component of the coating liquid is 0.005% or more but 5% or less by mass.

A functional layer, such as the hard-coat layer and the overcoat layer, can contain an acrylic-based or other surfactant (surface-adjusting agent, levelling agent). Examples of acrylic-based surfactants include the following products manufactured by BYK-Chemie GmbH: BYK-350, BYK-354, BYK-355/356, BYK-358N/361N, BYK-381, BYK-392, BYK-394, and BYK-3441; and the following products manufactured by Kyoeisha Chemical Co., Ltd.: POLYFLOW No. 7, POLYFLOW No. 50E, POLYFLOW No. 50EHF, POLYFLOW No. 54N, POLYFLOW No. 75, POLYFLOW No. 77, POLYFLOW No. 85, POLYFLOW No. 85HF, POLYFLOW No. 90, POLYFLOW No. 90D-50, POLYFLOW No. 95, POLYFLOW PW-95, and POLYFLOW No. 99C. Other surfactants include the following products manufactured by BYK-Chemie GmbH: BYK-399, BYK-3440, BYK-3550, BYK-SILCLEAN 3700, BYK-SILCLEAN 3720, and BYK-DYNWET 800; and the following products manufactured by Nissin Chemical Co., Ltd.: Surfynol 104E, Surfynol 104H, Surfynol 104A, Surfynol 104PA, Surfynol 104PG-50, Surfynol 104S, Surfynol 420, Surfynol 440, Surfynol 465, Surfynol 485, Surfynol SE, Surfynol SE-F, Surfynol PSA-336, Surfynol 61, Dinol 604, Dinol 607, Surfynol 2502, and Surfynol 82.

It is preferable that the hard-coat layer according to the embodiment be laid by coating a film base material with a hard-coat layer composition diluted in a solvent and then drying and curing the coating by a method as will be described below. Preferred solvents are ketones and esters.

Examples of ketones include methylethyl ketone, acetone, cyclohexanone, and methylisobutyl ketone.

Examples of esters include, but are not limited to, methyl acetate, ethyl acetate, butyl acetate, and propyl and acetate.

Examples of other preferred solvents include alcohols (such as ethanol, methanol, butanol, n-propyl alcohol, isopropyl alcohol, and diacetone alcohol), hydrocarbons (toluene, xylene, benzene, and cyclohexane), glycol ethers (propyleneglycolmonomethyl ether, propyleneglycolmonopropyl ether, and ethyleneglycol monopropyl ether). Using 20 to 200 parts by mass of the solvent for 100 parts of the active energy ray-curable resin contained in the hard-coat layer yields a hard-coat layer composition with excellent stability.

A preferred amount of coating is 0.1 to 40 μm in terms of wet film thickness, and more preferably 0.5 to 30 μm. A preferred dry film thickness is 0.1 to 30 μm in terms of mean thickness, more preferably 1 to 20 μm, and particularly preferably 4 to 15 μm.

(Method for Producing the Hard-Coat Layer)

The hard-coat layer is produced by one of well-known coating methods such as gravure coating, dip coating, reverse coating, wire bar coating, die (extrusion) coating, and ink-jetting; by one of those methods, a hard-coat layer composition for forming the hard-coat layer is applied, is then dried, is then UV-cured, and is then, as necessary, heated. The temperature in the heating after the UV-curing is preferably 80° or more, more preferably 100° C. or higher, and particularly preferably 120° C. or higher. Heating at a high temperature after UV-curing in this way yields a hard-coat layer with excellent mechanical strength (abrasion resistance, pencil hardness).

Drying is preferably performed at a high temperature of 90° C. or higher during a decreasing-rate drying period, and more preferably at 95° C. or higher but 130° C. or lower. Drying at a high temperature during the decreasing-rate drying period causes convection to occur in the coating resin during the formation of the hard-coat layer; this makes it more likely the hard-coat layer develops a fine asperity at the surface, and thus makes it easier to obtain a desired arithmetic mean coarseness Ra.

It is generally known that, in a drying process, as drying progresses, the drying speed, which is at first constant, gradually decreases. The period during which the drying speed is constant is called constant-rate drying period, and the period during which the drying speed decreases is called decreasing-rate drying period. In the constant-rate drying period, all the heat input is expended on vaporization of the solvent at the coating surface; as the amount of solvent at the coating surface decreases, the evaporation front moves from the surface inward, the decreasing-rate drying period thus starting. Thereafter, the temperature at the coating surface increases to be closer and closer to the hot air temperature, and increases the temperature of the hard-coat layer composition; this is considered to reduce the viscosity of the active energy ray-curable resin in the hard-coat layer composition, leading to increased flowability.

As a light source for UV-curing, any light source that generates ultraviolet rays can be used. For example, it is possible to use a low-pressure mercury lamp, medium-pressure mercury lamp, high-pressure mercury lamp, ultrahigh-pressure mercury lamp, carbon arc lamp, metal halide lamp, xenon lamp, or the like. While irradiation conditions vary from one type of lamp to another, a typical amount of irradiation is preferably 50 to 1000 mJ/cm², and more preferably 50 to 300 mJ/cm².

<Organic Compounds Capable of Absorbing Ultraviolet Rays>

The hard-coat layer described above contains an organic compound capable of absorbing ultraviolet rays (hereinafter also referred to as an ultraviolet ray-absorbing compound). In the embodiment, it is possible to use an ultraviolet ray-absorbing compound with a melting point of 20° C. or lower, and an ultraviolet ray-absorbing compound having an ester group in the molecule.

An ultraviolet ray-absorbing compound with a melting point of 20° C. or lower can be used in combination with an ultraviolet ray-absorbing compound with a melting point higher than 20° C. Likewise, an ultraviolet ray-absorbing compound having an ester group in the molecule can be used in combination with an ultraviolet ray-absorbing compound having no ester group in the molecule.

An ultraviolet ray-absorbing compound used in the embodiment have only to have a melting point of 20° C. or lower. Specific examples include benzotriazole-based compounds, salicylic acid ester-based compounds, benzophenone-based compounds, and cyanoacrylate-based claims, among which benzotriazole-based compounds are particularly preferred.

Furthermore, for compatibility with the resin in the hard-coat layer, an ultraviolet ray-absorbing compound according to the embodiment preferably has an alkyl chain, alkenyl chain, alkylene chain, or alkyleneoxide chain with a carbon number of 8 or more.

Moreover, an ultraviolet ray-absorbing compound according to the embodiment preferably has a molecular weight of 3000 or less, and more particularly 2000 or less.

As an ultraviolet ray-absorbing compound that can be used in combination with the above-described ultraviolet ray-absorbing compound, any ultraviolet ray-absorbing compound in common use can be used. Specific examples include oxybenzophenone-based compounds, benzotriazole-based compounds, salicylic ester-based compounds, benzophenone-based compounds, cyanoacrylate-based compounds, and nickel complex salt-based compounds, among which benzotriazole-based compounds are preferred (e.g., TINUVIN 928 (manufactured by BASF Japan Ltd.)).

Specific examples of ultraviolet ray-absorbing compounds usable in the present invention are, but not limited to, as follows:

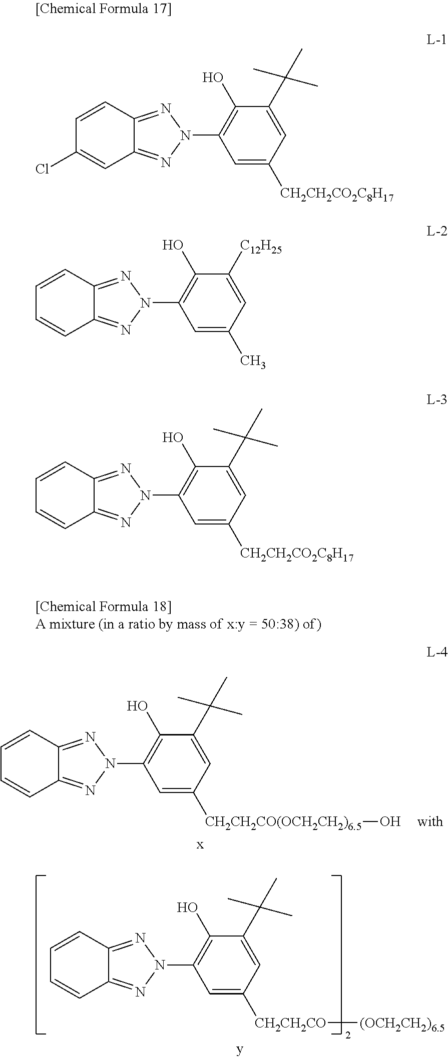

A stacked film according to the embodiment can further have, in addition to the curing layer described above, another functional layer. In the embodiment, there is no particular restriction on such other functional layers. Functional layers encompass a variety of applications, examples including an anti-reflection layer, low refraction index layer, hard-coat layer, light scattering layer, light diffusing layer, antistatic layer, electrically conductive layer, electrode layer, birefringent layer, surface energy adjustment layer, UV absorbing layer, coloring layer, water-resistant layer, barrier layer to a particular gas, heat resistant layer, magnetic layer, antioxidant layer, and overcoat layer.

[Method for Producing an Long Obliquely Stretched Film]

The quarter-wave film described above can be produced by a method for producing a long obliquely stretched film as will be described below. A long obliquely stretched film denotes an obliquely stretched film in the form of a long sheet of which the orientation direction is inclined with respect to the length and width directions of the film which are perpendicular to each other.

The orientation direction of a long obliquely stretched film, that is, the direction of its slow axis, forms an angle larger than 0° but smaller than 90° with respect to the width direction of the film within the film plane (and thus automatically forms an angle larger than 0° but smaller than 90° with respect to the length direction of the film). The slow axis typically appears in the stretching direction or in the direction perpendicular to the stretching direction; thus, by stretching the film in a direction that forms an angle larger than 0° but smaller than 90° with respect to the width direction of the film, it is possible to produce a long obliquely stretched film having such a slow axis.

In the embodiment, a “long” film denotes a film that has a length at least five times as large as its width, and more preferably a length ten or more times as large as the width; specifically, it can be a film with such a length that it is stored and transported in a form wound in a roll (i.e., a film roll).

In the production of a long obliquely stretched film, by producing the film continuously, it is possible to produce films in desired lengths. A long obliquely stretched film can be produced by first forming a long film and winding it around a bobbin into a roll (a full long film roll), and then feeding the long film out of the roll to an oblique stretching process; or instead by feeding a formed long film continuously, i.e., without winding it, from the film formation process to an oblique stretching process. It is preferable to perform the film formation process and the stretching process continuously, because it is then possible to feed back results such as the film thickness and optical values of the stretched film to adjust the film formation conditions so as to obtain a long obliquely stretched film as desired.

Hereinafter, one mode of carrying out the present invention will be described specifically with reference to the relevant drawings. In the following description, a “long film” denotes a film in the form of a long film as a target of stretching in an oblique stretching process, and is to be distinguished from a long obliquely stretched film having undergone the oblique stretching process.

<Formation of a Long Film>

A long film according to the embodiment can be produced by solution flow casting or melt flow casting as described below. These film formation processes will be described below one by one. Although the following description deals with cases where, as a long film, a cellulose ester-based resin film is produced, it applies equally to film formation of any other resin film.

[Solution Flow Casting]

From the viewpoints of suppressing film coloring, suppressing foreign-matter defects, suppressing optical defects such as die lines, and excellent film flatness and transparency, it is preferable to produce a long film by solution flow casting.

(Organic Solvent)

As an organic solvent useful in forming a dope in a case where a cellulose ester-based resin film according to the embodiment is produced by solution flow casting, any solvent can be used with no restriction so long as both cellulose acetate and other additives dissolve in it.

An example of a chlorinated organic solvent is methylene chloride. Examples of non-chlorinated solvents include methyl acetate, ethyl acetate, amyl acetate, acetone, tetrahydrofurane, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane. Preferred among these are methylene chloride, methyl acetate, ethyl acetate, and acetone.

It is preferable that the dope contain, in addition to the above-mentioned solvent, 1 to 40% by mass of a straight-chained or branched aliphatic alcohol with a carbon number of 1 to 4. A high content of the alcohol in the dope causes gelation of the web, allowing easy release from a metal support member; on the other hand, a low content of the alcohol promotes dissolution of cellulose acetate in a non-chlorinated organic solvent.

Particularly preferred is a dope composition prepared by dissolving at least a total of 15 to 45% by mass of three materials, namely acrylic resin, cellulose ester resin, and acrylic particles, in a solvent containing methylene chloride and a straight-chained or branched aliphatic alcohol with a carbon number of 1 to 4.

Examples of straight-chained or branched aliphatic alcohols with carbon numbers of 1 to 4 include methanol, ethanol, n-propanol, iso-propanol, n-butanol, sec-butanol, and tert-butanol. Preferred among these for dope stability, a comparatively low boiling point, and quick drying is ethanol.

(Solution Flow Casting)

A cellulose ester resin-based film according to the embodiment can be produced by solution flow casting. Solution flow casting involves a step of preparing a dope by dissolving resin and additives in a solution, a step of flow-casting the dope on a metal support member in the shape of a belt or a drum, a step of drying the flow-cast dope in the form of a web, a step of releasing from the metal support member, a step of stretching or width keeping, a step of further drying, and a step of winding up the finished film.

The higher the concentration of cellulose acetate in the dope, advantageously the lower the drying burden after flow casting on the metal support member. An excessively high concentration, however, leads to an increased burden in filtering, inviting lower filtering accuracy. To strike a good balance, the concentration is preferably 10 to 35% by mass, and more preferably 15 to 25% by mass. Suitably used as the metal support member for flow casting is one having a mirror-finished surface, and suitably used as the metal support member is a stainless steel belt, or a cast drum with a surface finished by plating.

The surface temperature of the metal support member in the flow casting step is set at −50° C. or higher but below a temperature at which the solvent boils and forms bubbles. The higher the temperature of the support member, advantageously the more quickly the web dries, but an excessively high temperature causes bubble formation in the web or degraded flatness.

A preferred temperature of the support member is determined as desired in the range of 0 to 100° C., and more preferably in the range of 5 to 30° C. One preferred method is to cool the web to gelate it so that it is released from the drum in a state containing a large proportion of residual solvent. There is no particular restriction on the method of controlling the temperature of the metal support member, examples including a method involving blowing heated or cooled air onto it, and a method involving bringing heated water into contact with the underside of the metal support member. Using heated water is preferred, because it allows efficient transfer of heat and takes less time until the temperature of the metal support member becomes constant.

In a case where heated air is used, with consideration given to a drop in the temperature of the web ascribable to latent heat of vaporization of the solvent, air heated to over the boiling point of the solvent can be used such that, while air at a temperature higher than the target temperature is used, bubble formation is prevented.

It is particularly preferable to perform drying efficiently by varying the temperature of the support member and the temperature of the drying wind between flow casting and releasing.

For a cellulose ester resin-based film to exhibit satisfactory flatness, it is preferable that the amount of residual solvent at the time that the web is released from the metal support member be in the range of 10 to 150% by mass, more preferably 20 to 40% by mass or 60 to 130% by mass, and particularly preferably 20 to 30% by mass or 70 to 120% by mass. Here, the amount of residual solvent is defined by the following formula.

Amount of Residual Solvent(% by mass)=[(M−N)/N]×100

Here, M represents the mass (g) of the sample collected at an arbitrary time point during or after the production of the web or the film, and N represents the mass (g) after heating of the same sample at 115° C. for one hour.

In the step of drying the cellulose ester resin-based film, it is preferable to release the web from the metal support member and then further dry it such that the amount of residual solvent is 1% or less by mass, more preferably 0.1% or less by mass, and particularly preferably 0 to 0.01% or less by mass.

Typically adopted in the step of drying the film is a method where the web is dried while being transported, such as a roll drying method (where the web is dried by being passed between a large number of rolls arranged under and over it) or a tenter method.

[Melt Flow Casting]

Melt flow casting is preferred from the viewpoint of ease of reducing retardation Rt in the thickness direction of the film after oblique stretching, which will be described later, and from other view points such as a reduced amount of residual volatile components and excellent dimensional stability. Melt flow casting involves heating a composition containing resin and additives such as a plasticizer up to a temperature at which it exhibits fluidity, and then flow-casting the melt containing fluid cellulose acetate to form a film. Processes involving melt flow casting can be classified into melt extrusion (formation), press molding, inflation, injection molding, blow molding, draw molding, etc. Among these, melt extrusion is preferred because it produces a film with excellent mechanical strength, surface accuracy, etc. In general, it is preferable that the plurality of source materials to be used in melt extrusion be previously blended and kneaded and pelletized.

Pelletizing can be performed by a well-known method. For example, dry cellulose acetate, plasticizer, and other additives are fed from a feeder into an extruder; then, on a single-axis or two-axis extruder, the mixture is blended and kneaded, and is extruded from a die in the form of a strand, which is then cooled with water or air, and is then cut into pellets.

The additives can be mixed before feeding into the extruder, or can be fed from separate feeders. For even mixing, it is preferable that additives added in small amounts, such as particles and antioxidant, be mixed beforehand.

It is preferable that the extruder be operated with a suppressed shearing force, and that, to prevent deterioration of resin (reduced molecular weight, coloring, or gel formation), the working proceed in a pelletizable fashion and at as low a temperature as possible. For example, on a two-axis extruder, it is preferable to rotate the two axes in the same direction by use of deep-groove screws. For even blending and kneading, a meshed-together type is preferred.

By use of the pellets obtained as described above, film formation is performed.

Needless to say, unpelletized source materials in powder form as they are can be fed from a feeder into an extruder to perform film formation.

On a single-axis or two-axis extruder, the pellets described above are subjected to extrusion at a melt temperature of about 200 to 300° C.; the melt is then subjected to filtering with a leaf-disc filter or the like to remove foreign matter, is then flow-cast into a film from a T-die; the film is then nipped between a cooling roll and an elastic touch roll so as to cure on the cooling roll.

It is preferable that the feeding of the pellets from the feed hopper into the extruder be performed under vacuum, under reduced pressure, or under an environment of an inert gas to prevent decomposition due to oxidation or the like.

It is preferable that extrusion be performed at a stable flow rate with a gear pump or the like introduced. Suitably used as a filter for foreign matter removal is a stainless fiber sintered filter. A stainless fiber sintered filter is formed by compressing a complex tangle of stainless fibers and then sintering the contact spots to form a single piece. It is possible to vary its density by varying the fiber thickness and the degree of compression, and thereby to adjust filtering precision.

Additives such as plasticizer and particles can be previously mixed with resin, or can be kneaded in in the middle of the extruder. For even addition, it is preferable to use a mixing device such as a static mixer.

When the film is nipped between the cooling roll and the elastic touch roll, it is preferable that the touch roll-side temperature of the film be equal to or higher than the film's Tg (glass transition temperature) but equal to or lower than Tg+110° C. As a roll having a surface of an elastic material for use for such a purpose, a well-known roll can be used.

An elastic touch roll is also referred to as a nip rotary member. As an elastic touch roll, a commercially available one can be used.

When the film is released from the cooling roll, it is preferable to control the tension so as to prevent deformation of the film.

A long film produced by any of the film formation processes described above can be a single-layer film, or a stacked film having two or more layers. A stacked film can be obtained by a well-known process such as co-extrusion molding, co-flow casting, film lamination, or coating. Of these, co-extrusion molding and co-flow casting are preferred.

(Specifications of a Long Film)

A long film according to the embodiment has a thickness of 10 to 70 μm, preferably 10 to 60 μm, more preferably 10 to 50 μm, and still more preferably 15 to 35 μm. In the embodiment, the thickness unevenness σm in the flow direction (transport direction) of the long film fed to the stretching zone, which will be described later, needs to be less than 0.30 μm, preferably less than 0.25 μm, and more preferably less than 0.20 μm from the viewpoint of keeping constant the drawing tension of the film at the entrance of the oblique stretching tenter, which will be descried later, and from the viewpoint of stabilizing optical properties such as orientation angle and retardation. If the thickness unevenness σm in the flow direction of the long film is 0.30 μm or more, variation in optical properties such as retardation and orientation angle degrades notably.

As a long film, a film having a thickness gradient in the width direction can be fed.

The thickness gradient of a long film can be found empirically by stretching a film whose thickness gradient is varied experimentally such that the film thickness at the position where stretching in post-processing is complete is most even. The thickness gradient of a long film can be adjusted, for example, such that the thickness at the end with the larger thickness is about 0.5 to 3% more than the thickness at the end with the smaller thickness.

The width of a long film is subject to no particular restriction, and can be in the range of 500 to 4000 mm, and preferably in the range of 1000 to 2000 mm.

A preferred modulus of elasticity at the stretching temperature during oblique stretching of the long film, as expressed in terms of Young's modulus, is 0.01 MPa or more but 5000 MPa or less, and more preferably 0.1 MPa or more but 500 MPa or less. If the modulus of elasticity is too low, the shrinkage ratio during and after stretching is so low that creases are hard to remove. If the modulus of elasticity is too high, the tension applied during stretching is so high that increased mechanical strength is required in the parts that hold both side edge portions of the film, increasing the burden on the tenter in post-processing.

As a long film, a non-oriented film can be used, or a pre-oriented film can be fed. If necessary, a long film can be oriented in an arcuate, that is, so-called bow-shaped, distribution in the width direction. In short, the orientation state of the long film can be adjusted such that a desired film orientation is obtained at the position where stretching in post-processing is complete.

<Method and Apparatus for Production of an Obliquely Stretched Film>

Next, a description will be given of an obliquely stretched film production method and an obliquely stretched film production apparatus for stretching the above-described long film in a direction oblique to the width direction to produce an obliquely stretched film in the form of a long film.

(Outline of the Apparatus)

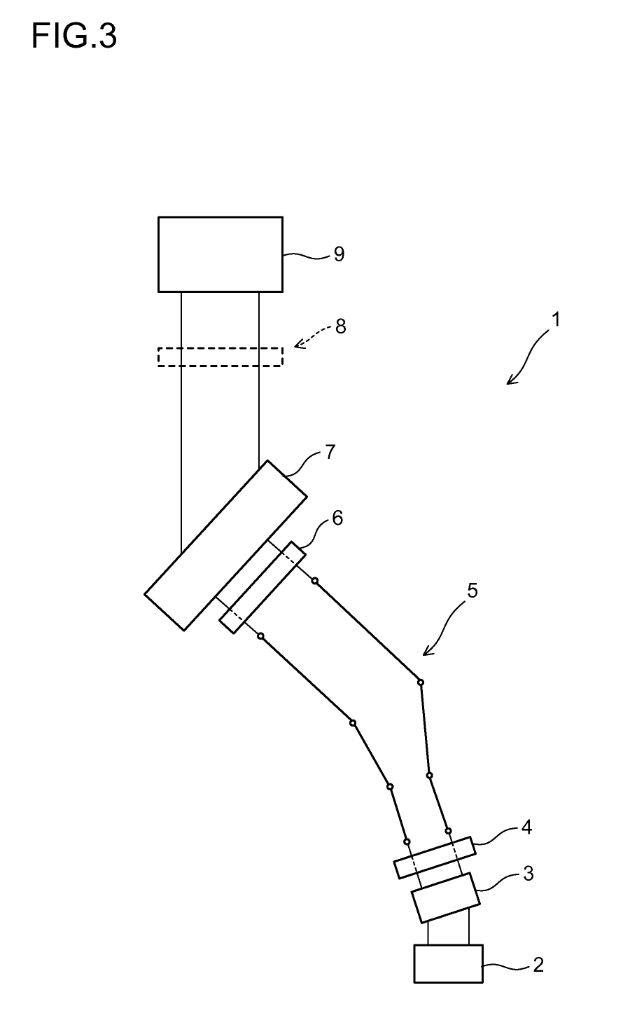

FIG. 3 is a plan view schematically showing an outline configuration of an obliquely stretched film production apparatus 1. The production apparatus 1 is provided with, from the upstream side with respect to the transport direction of the long film, a film dispensing portion 2, a transport direction changing portion 3, a guide roll 4, a stretching portion 5, a guide roll 6, a transport direction changing portion 7, a film cutting device 8, and a film winding portion 9. The stretching portion 5 will be described in detail later.

The film dispensing portion 2 dispenses the long film described above to feed it to the stretching portion 5. The film dispensing portion 2 can be configured as a separate unit from, or can be configured integrally with, the long film formation apparatus. In the former case, the long film after film formation is first wound around a bobbin into a roll (a full long film roll), which is then loaded on the film dispensing portion 2, so that the long film is dispensed from the film dispensing portion 2. On the other hand, in the latter case, the film dispensing portion 2 feeds the long film after film formation, without ever winding it up, to the stretching portion 5.

The transport direction changing portion 3 changes the transport direction of the long film dispensed from the film dispensing portion 2 to a direction toward the entrance of the stretching portion 5 as an oblique stretching tenter. The transport direction changing portion 3 is configured to include, for example, a turn bar which changes the transport direction by turning over the film while transporting it, and a rotary table which permits the turn bar to turn in a plane parallel to the film.

By changing the transport direction of the long film in the transport direction changing portion 3 as described above, it is possible to reduce the width of the production apparatus 1 as a whole, and also to finely control the film dispensing position and angle, making it possible to produce a long obliquely stretched film with little variation in film thickness and optical values. By configuring the film dispensing portion 2 and the transport direction changing portion 3 to be movable (slidable, rotatable), it is possible to effectively prevent improper clamping of the film by left and right clips (holding members) which hold the film at both end portions in the width direction.

The film dispensing portion 2 can be configured to be slidable and rotatable such that it can dispense the long film at a predetermined angle relative to the entrance of the stretching portion 5. In that case, the provision of the transport direction changing portion 3 can be omitted.

At least one guide roll 4 is provided on the upstream side of the stretching portion 5 to stabilize the path of the long film in motion. The guide roll 4 can be composed of a pair of upper and lower rolls sandwiching the film, or can be composed of a plurality of pairs of rolls. The guide roll 4 closest to the entrance of the stretching portion 5 is a follower roll which guides the motion of the film, and is rotatably pivoted on unillustrated bearings. As the material for the guide roll 4, any well-known material can be used. To prevent the film from being scratched, it is preferable to apply a ceramic coating on the surface of the guide roll 4, or to reduce the weight of the guide roll 4 as by using a light metal such as aluminum plated with chromium.

It is preferable that one of the rolls provided on the upstream side of the guide roll 4 closest to the entrance of the stretching portion 5 be brought in pressed contact with a rubber roller to form a nip. Such a nip roll helps suppress variation in the dispensing tension in the film flow direction.

At the pair of bearings at both (left and right) ends of the guide roll 4 closest to the entrance of the stretching portion 5, there are provided a first and a second tension detection device as film tension detection devices for detecting the tension occurring in the film at that roll. As the film tension detection devices, for example, load cells can be used. As load cells, well-known ones of a tension type or a compression type can be used. A load cell is a device that detects a load acting on a point of application by converting it into an electrical signal with a strain gauge fitted to a strain producing member.

Provided at the left and right bearings of the guide roll 4 closest to the entrance of the stretching portion 5, the load cells detect, at the left and right sides independently, the force that the film in motion acts on the roll, that is, the tension occurring near both side edges of the film in the film movement direction. The strain gauges can be fitted directly to the support member constituting the bearings of the roll such that, based on the strain occurring in the support member, the load, that is, the film tension, is detected. It is assumed that the relationship between the occurring strain and the film tension is previously measured and known.

When the position and the transport direction of the film fed from the film dispensing portion 2 or the transport direction changing portion 3 to the stretching portion 5 is deviated from the position and the transport direction toward the entrance of the stretching portion 5, in proportion to the amount of the deviation, a difference arises in the tension near both side edges of the film at the guide roll 4 closest to the entrance of the stretching portion 5. Thus, by detecting this difference in tension by the provision of the film tension detecting devices described above, it is possible to discriminate the degree of the deviation. That is, if the transport position and the transport direction of the film are proper (if they are the position and direction toward the entrance of the stretching portion 5), the load that acts on the guide roll 4 is roughly even at both ends in the axial direction; if they are not proper, a difference arises in the film tension between the left and right sides.

Thus, by properly adjusting the position and transport direction (the angle relative to the entrance of the stretching portion 5) of the film, for example, by means of the transport direction changing portion 3 described above such that the tension of the film is equal between the left and right sides at the guide roll 4 closest to the entrance of the stretching portion 5, it is possible to stabilize the holding of the film by the holding members at the entrance of the stretching portion 5, and to reduce the incidence of troubles such as unexpected release from the holding members. It is also possible to stabilize the physical properties in the width direction of the film after oblique stretching by the stretching portion 5.

At least one guide roll 6 is provided on the downstream side of the stretching portion 5 to stabilize the path of the film in motion after oblique stretching by the stretching portion 5.

The transport direction changing portion 7 changes the transport direction of the film after stretching transported from the stretching portion 5 to a direction toward the film winding portion 9.

Here, to allow for fine adjustment of the orientation angle (the direction of the planar slow axis of the film) and product variation, it is necessary to adjust the angle between the film transport direction at the entrance of the stretching portion 5 and the film transport direction at the exit of the stretching portion 5. For this angle adjustment, it is necessary to change, by the transport direction changing portion 3, the transport direction of the film after film formation so as to direct the film to the entrance of the stretching portion 5, and/or to change, by the transport direction changing portion 7, the transport direction of the film having left the exit of the stretching portion 5 so as to direct the film back in the direction of the film winding portion 9.

It is preferable to perform film formation and oblique stretching continuously from the viewpoints of productivity and yield. In a case where the film formation step, the oblique stretching step, and the winding step are performed continuously, the transport direction of the film is changed by the transport direction changing portion 3 and/or the transport direction changing portion 7 such that the film movement direction is aligned between the film formation step and the winding step. That is, as shown in FIG. 3, the movement direction (dispensing direction) of the film dispensed from the film dispensing portion 2 and the movement direction (winding direction) of the film immediately before being wound up in the film winding portion 9 are aligned with each other, and this helps reduce the width of the apparatus as a whole with respect to the film movement direction.

Incidentally, the film movement direction does not necessarily have to be aligned between the film formation step and the winding step. However, to obtain a layout where the film dispensing portion 2 and the film winding portion 9 do not interfere with each other, it is preferable to change the movement direction of the film by the transport direction changing portion 3 and/or the transport direction changing portion 7.

The transport direction changing portions 3 and 7 described above can be implemented by a well-known technique, as by use of an air flow roll or an air turn bar.

The film cutting device 8 cuts the film (long obliquely stretched film) stretched by the stretching portion 5 across a cross-sectional plane including the width direction, and has a cutting member. The cutting member can be scissors or a cutter (such as a slitter or a strip-form blade (Thomson blade)), but this is not meant as any limitation; it can also be configured as a rotary circular saw or a laser cutter.

The film winding portion 9 winds up the film transported from the stretching portion 5 via the transport direction changing portion 7, and is composed of, for example, a winder device, an accumulation device, or a drive device. The film winding portion 9 is preferably so configured as to be slidable in the lateral direction to allow adjustment of the film winding position.

The film winding portion 9 is so configured as to allow fine control of the film drawing position and angle to permit the film to be drawn at a predetermined angle relative to the exit of the stretching portion 5. This makes it possible to obtain a long obliquely stretched film with little variation in film thickness and optical values. It is also possible to effectively prevent development of creases in the film, and to improve film windability, permitting a long film to be wound up.

The film winding portion 9 constitutes a film drawing portion which draws, with a predetermined tension, the film transported after being stretched by the stretching portion 5. A drawing roll for drawing the film with a predetermined tension can be provided between the stretching portion 5 and the film winding portion 9. The guide roll 6 described above can be configured to function also as a drawing roll.

In the embodiment, the drawing tension T (N/m) after stretching is adjusted in the range 100 N/m<T<300 N/m, and preferably in the range 150 N/m<T<250 N/m. With a drawing tension of 100 N/m or less, sags and creases are likely to develop in the film, and also the retardation and the profile of the orientation angle in the film width direction are degraded. On the other hand, with a drawing tension of 300 N/m or more, variation of the orientation angle in the film width direction is degraded, and thus the width yield (the production yield in the width direction) is degraded.

In the embodiment, it is preferable to control the variation of the above-mentioned drawing tension T with an accuracy of less than ±5%, and preferably less than ±3%. With the variation of the above-mentioned drawing tension T±5% or more, larger variation results in optical properties in the width direction and in the flow direction (transport direction). According to one method of controlling the variation of the above-mentioned drawing tension T within the above-mentioned ranges, the load acting on the first roll (guide roll 6) on the exit side of the stretching portion 5, that is, the film tension, is measured, and so that this may have a constant value, the rotation speed of the drawing roll or of the winding roll in the film winding portion 9 is controlled by a commonly practiced PID control method. According to one example of a method of measuring the above-mentioned load, a load cell is fitted to a bearing of the guide roll 6, and the load that acts on the guide roll 6, that is, the tension of the film, is measured. As the load cell, a well-known one of a tension type or a compression type can be used.

The film after stretching is released from the holding by the holding members of the stretching portion 5, and is then discharged from the exit of the stretching portion 5. The both ends (at both sides) of the film, which have been held by the holding members, are then trimmed off as necessary. Thereafter, the film is cut into predetermined lengths by the film cutting device 8, and is then successively wound up around a bobbin (winding roll) into a roll of an obliquely stretched film.

Before the obliquely stretched film is wound up, to prevent blocking of the film with itself, the obliquely stretched film may be overlaid with a masking film so that the two are wound up together, or the winding may be performed while tape or the like is applied to at least one end (preferably, both ends) of the obliquely stretched film which overlaps itself as the film is wound up. There is no particular restriction on the masking film so long as it can protect the obliquely stretched film, examples including a polyethylene terephthalate film, a polyethylene film, and a polypropylene film.

(Details of the Stretching Portion)

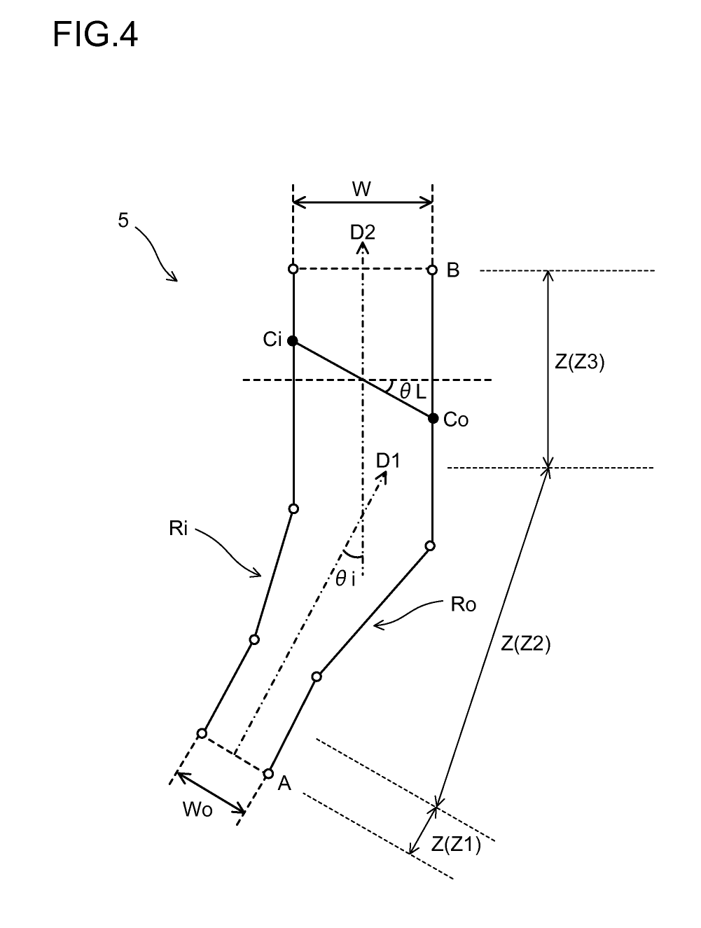

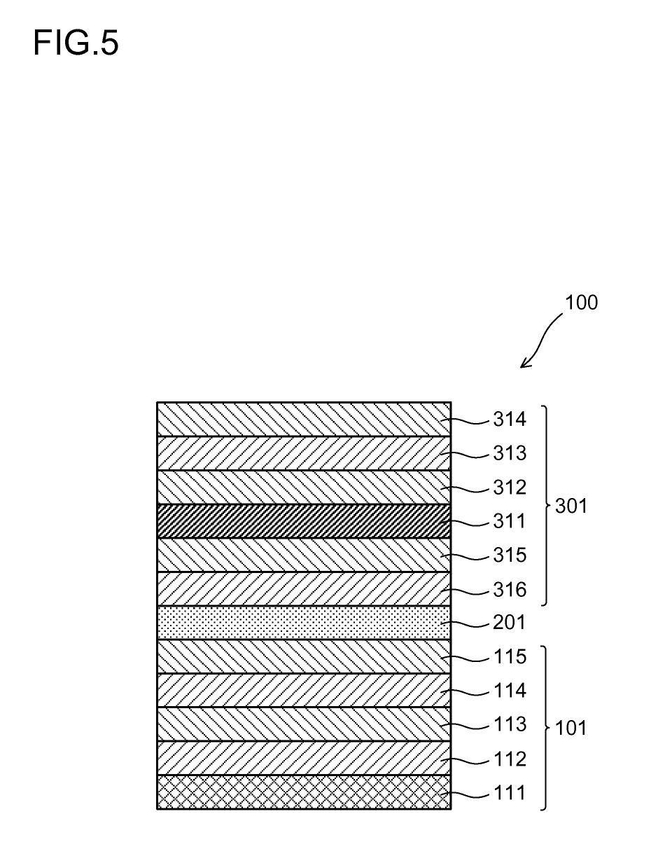

Next, the stretching portion 5 mentioned above will be described in detail. FIG. 4 is a plan view schematically showing an example of a rail pattern of the stretching portion 5. This is merely one example, and is not meant to limit the configuration of the stretching portion 5.

The production of a long obliquely stretched film according to the embodiment is performed by use of, as the stretching portion 5, a tenter (an oblique stretcher) capable of oblique stretching. The tenter is a device that heats the long film to an arbitrary temperature at which it can be stretched and that stretches it obliquely. The tenter is provided with a heating zone Z, a pair of left-hand and right-hand rails Ri and Ro, and a number of holding members Ci and Co which move along the rails Ri and Ro to transport the film (in FIG. 4, only one pair of holding members is illustrated). The heating zone Z will be described in detail later. The rails Ri and Ro are each composed of a plurality of rail segments coupled together by couplers (in FIG. 4, white circles represent an example of couplers). The holding members Ci and Co are composed of clips that hold both ends of the film in the width direction.

In FIG. 4, the dispensing direction D1 of the long film differs from the winding direction D2 of the long obliquely stretched film after stretching, and has a dispensing angle θi relative to the winding direction D2. The dispensing angle θi can be an arbitrary angle in the range larger than 0° but smaller than 90°.

With the dispensing direction D1 and the winding direction D2 different as described above, the tenter has a rail pattern that is non-symmetrical left to right. The rail pattern can be adjusted manually or automatically according to the orientation angle θ, the stretching factor, etc. to be given to the long obliquely stretched film to be produced. In the oblique stretcher used in a production method according to the embodiment, preferably, the positions of each of the rail segments and rail couplers constituting the rails Ri and Ro can be set freely so that the rail pattern can be changed freely.

In the embodiment, the holding members Ci and Co of the tenter are so configured as to move at constant speed while keeping constant intervals from those running ahead of and behind themselves. The movement speed of the holding members Ci and Co can be selected as desired, and is typically in the range of 1 to 150 m/minute. The difference in movement speed between the pair of left-hand and right-hand holding members Ci and Co is typically 1% or less, preferably 0.5% or less, and more preferably 0.1% or less. This is because, if there is a difference in movement speed between the left and right sides at the exit of the stretching step, creaks develop and siding occurs at the exit of the stretching step, and therefore the speed of the left and right holding members needs to be substantially equal. In common tenter devices and the like, speed variation of the order of a second or less occurs according to the cycle of the cogs of a sprocket for driving a chain, the frequency of the driving motor, etc., and this often produces variation of several %. This, however, does not correspond to what is referred to as a difference in speed in the embodiment of the present invention.

In the oblique stretcher used in a production method according to the embodiment, in particular at a location where the film is transported obliquely, the rails, which restrict the loci of the holding members, are often required to have a large curvature. With a view to preventing interference of holding members with one another due to a sharp bend and preventing local concentration of stress, it is preferable that, in the bent portion, the loci of the holding members describe curves.

As described above, it is preferable that an oblique stretching tenter used to give a long film an oblique orientation be one that can set the orientation angle of the film freely by varying the rail pattern in many ways, that can align the orientation axis (slow axis) of the film evenly between the left and right sides over the entire film width direction with high accuracy, and that in addition can control film thickness and retardation with high accuracy.

Next, stretching operation in the stretching portion 5 will be described. The long film is held at both ends thereof by the left and right holding members Ci and Co, and is transported through the heating zone Z as the holding members Ci and Co move. The left and right holding members Ci and Co are located in an entrance portion of the stretching portion 5 (at position A in the drawing), opposite each other in a direction substantially perpendicular to the film movement direction (dispensing direction D1); move on the rails Ri and Ro respectively, which are non-symmetrical left to right; and release the film, which they have been holding, in an exit portion (position B in the drawing) where stretching ends. The film released from the holding members Ci and Co is wound up around a bobbin in the above-described film winding portion 9. The paired rails Ri and Ro each have an endless continuous track, and thus the holding members Ci and Co having released the film in the exit portion of the tenter then move along outer rails and return to the entrance portion successively.

Here, since the rails Ri and Ro are non-symmetrical left to right, in the example shown in FIG. 4, as the left and right holding members Ci and Co, which are located opposite each other at position A in the diagram, move along the rails Ri and Ro, the holding member Ci moving along the rail Ri (inside track) comes to run ahead of the holding member Co moving along the rail Ro (outside track).

Specifically, of the holding members Ci and Co, which are located opposite each other in a direction substantially perpendicular to the dispensing film direction D1 at position A in the drawing, one holding member Ci reaches position B first, at which time point the straight line through the holding members Ci and Co is inclined at an angle θL relative to a direction substantially perpendicular to the film winding direction D2. With this behavior, the long film is stretched obliquely at an angle of θL relative to the width direction. Here, “substantially perpendicular” denotes being at an angle in the range of 90±1°.

Next, the heating zone Z mentioned above will be described in detail. The heating zone Z of the stretching portion 5 is composed of a preheating zone Z1, a stretching zone Z2, and a heat-fixing zone Z3. In the stretching portion 5, the film held by the holding members Ci and Co passes through the preheating zone Z1, the stretching zone Z2, and the heat-fixing zone Z3 in this order. In the embodiment, the pre-heating zone Z1 and the stretching zone Z2 are separated from each other by a partition wall, and the stretching zone Z2 and the heat-fixing zone Z3 are separated from each other by a partition wall.

The preheating zone Z1 is a zone located in an entrance portion of the heating zone Z where the holding members Ci and Co holding the film move while keeping a constant interval left to right (in the film width direction).

The stretching zone Z2 is a zone where the interval between the holding members Ci and Co holding the film widens until it becomes equal to a predetermined interval. Meanwhile, oblique stretching as described above is performed; as necessary, before or after oblique stretching, longitudinal or lateral stretching may also be performed.

The heat-fixing zone Z3 is a zone following the stretching zone Z2 where the interval between the holding members Ci and Co is constant again and where the holding members Ci and Co at both ends move parallel to each other.

Incidentally, the film after stretching may, after passing through the heat-fixing zone Z3, further pass through a zone (cooling zone) the temperature inside which is set to be equal to or less than the glass transition temperature Tg (° C.) of the thermoplastic resin forming the film. Here, shrinkage due to cooling may be taken into consideration by adopting a rail pattern that previously narrows the interval between the opposite holding members Ci and Co.

With respect to the glass transition temperature Tg of the thermoplastic resin, it is preferable to set the temperature in the preheating zone Z1 in the range of Tg to Tg+30° C., the temperature in the stretching zone Z2 in the range of Tg to Tg+30° C., and the temperature in the heat-fixing zone Z3 in the range of Tg−30 to Tg+20° C.

The lengths of the preheating zone Z1, the stretching zone Z2, and the heat-fixing zone Z3 are selected arbitrarily. With respect to the length of the stretching zone Z2, the length of the preheating zone Z1 is typically 100 to 150% and the length of the heat-fixing zone Z3 is typically 50 to 100%.

Let the width of the film before stretching be Wo (mm) and the width of the film after stretching be W (mm), then the stretching factor R (W/Wo) in the stretching step is preferably 1.3 to 3.0, and more preferably 1.5 to 2.8. With the stretching factor within these ranges, thickness unevenness in the width direction of the film is advantageously small. In the stretching zone Z2 of the oblique stretching tenter, introducing a difference in the stretching temperature in the width direction makes it possible to more satisfactorily suppress width-direction thickness unevenness. Incidentally, the above-mentioned stretching factor R is equal to the factor (W2/W1) by which the interval W1 between the clips at both ends when starting to hold in the entrance portion of the tenter widens to the interval W2 in the exit portion of the tenter.

The technique for oblique stretching in the stretching portion 5 is not limited to that described above; oblique stretching can instead be achieved, for example, by simultaneous two-axis stretching as disclosed in JP-A-2008-23775. In simultaneous two-axis stretching, a supplied long film is held at both end portions in the width direction with holding members, and as the holding members are moved, the long film is transported; meanwhile, with the transport direction of the long film kept unchanged, the movement speed of one holding member is made different from that of the other so that the long film is stretched in a direction oblique to the width direction. Oblique stretching can be performed also by a technique as disclosed in JP-A-2011-11434.

<Quality of a Long Obliquely Stretched Film>

In a long obliquely stretched film obtained by a production method according to the embodiment, it is preferable that the orientation angle θ be inclined, for example, in the range larger than 0° but smaller than 90° relative to the winding direction, and that, in the width direction, over a width of at least 1300 mm, the variation of the planar retardation Ro be 10 nm or less and the variation of the orientation angle θ be 10° or less. Moreover, it is preferable that the planar retardation value Ro (550) of the long obliquely stretched film as measured at a wavelength of 550 nm be in the range of 60 nm or more but 220 nm or less, more preferably 80 nm or more but 200 nm or less, and still more preferably 90 nm or more but 190 nm or less.

That is, in a long obliquely stretched film obtained by a production method according to the embodiment, it is preferable that the variation of the planar retardation Ro be, over at least 1300 mm in the width direction, 2 nm or less, and preferably 1 nm or less. By controlling the variation of the planar retardation Ro within the above-mentioned range, when a long obliquely stretched film is bonded to a polarizer to form a circular polarizing plate and this is applied to an organic EL image display device, it is possible to suppress color unevenness due to leakage of reflected external light during display of black. Also, when a long obliquely stretched film is used, for example, as a retardation film in a liquid crystal display device, it is possible to obtain satisfactory display quality.

In a long obliquely stretched film obtained by a production method according to the embodiment, it is preferable that the variation of the orientation angle θ be, over at least 1300 mm in the width direction, 10° or less, preferably 5° or less, and most preferably 1° or less. When a long obliquely stretched film with a variation more than 0.5° in the orientation angle θ is bonded to a polarizer to form a circular polarizing plate and this is installed in an image display device such as an organic EL image display device, light leakage occurs, possibly leading to lowered contrast between bright and dim.

Incidentally, Ro has the value calculated by taking the difference between the refraction index nx in the planar slow axis direction and the refraction index ny in the planer direction perpendicular to the slow axis and then multiplying the difference by the average thickness d of the film, that is, (Ro=(nx−ny)×d).

The average thickness of a long obliquely stretched film obtained by a production method according to the embodiment is, from the viewpoints of mechanical strength, thickness reduction in display devices, etc., 10 to 70 μm, preferably 10 to 60 μm, more preferably 10 to 50 μm, and particularly preferably 15 to 35 μm. The width-direction thickness unevenness in the long obliquely stretched film, since this affects windability, is preferably 3 μm or less, and more preferably 2 μm or less.

<Circular Polarizing Plate>

In the embodiment, a circular polarizing plate can be formed by stacking a polarizing plate protection film, a polarizer, and a quarter-wave film in this order. Here, the angle between the slow axis of the quarter-wave film and the absorption axis (or transmission axis) of the polarizer is 45°. In the embodiment, it is preferable that the circular polarizing plate be formed by stacking a polarizing plate protection film in the form of a long film, a polarizer in the form of a long film, and a quarter-wave film in the form of a long film (long obliquely stretched film) in this order.

In a circular polarizing plate according to the embodiment, used as the polarizer is one produced by stretching polyvinyl alcohol doped with iodine or a dichroic dye, and it can be produced in a form bonded in the structure (quarter-wave film)/(polarizer). The polarizer has a film thickness in the range of 5 to 40 μm, preferably 5 to 30 μm, and particularly preferably 5 to 20 μm.

The polarizing plate can be produced by a common method. It is preferable that an alkali-saponified quarter-wave film be bonded, by use of a water solution of fully saponified polyvinyl alcohol, to one side of a polarizer produced by immersion-stretching a polyvinyl alcohol-based film in an iodine solution.

A polarizing plate can also be formed by bonding a releasable film on the side of the above-described polarizing plate opposite from the polarizing plate protection film. The protection film and the releasable film are used for the purpose of protecting the polarizing plate during product inspection, shipment, etc.

<Organic EL Image Display Device>

FIG. 5 is a sectional view showing an outline structure of an organic EL image display device 100 according to the embodiment. This, however, is not meant to limit the configuration of the organic EL image display device 100.

The organic EL image display device 100 is formed by forming a circular polarizing plate 301 on top of an organic EL element 101 via an adhesive layer 201. The organic EL element 101 is configured to have a metal electrode 112, a light emission layer 113, a transparent electrode (such as ITO) 114, and a sealing layer 115 in this order on top of a substrate 111 of glass, polyimide, or the like. The metal electrode 112 can be composed of a reflective electrode and a transparent electrode.

The circular polarizing plate 301 is composed of an optical film 316, an adhesive layer 315, a polarizer 311, an adhesive layer 312, a quarter-wave film 313, and a curing layer 314 stacked in this order from the organic EL element 101 side. The optical film 316, the adhesive layer 315, the polarizer 311, the adhesive layer 312, the quarter-wave film 313, and the curing layer 314 here correspond respectively to the protective film 26, the adhesive layer 25, the polarizer 21, the adhesive layer 22, the quarter-wave film 23, and the curing layer 24 in FIG. 1. The optical film 316 here is a quarter-wave film, and the polarizer 311 and the optical film 316 are bonded together such that the transmission axis of the former and the slow axis of the latter form an angle of about 45° (or 135°). The organic EL image display device 100 further has members corresponding to the front window 13 and the filler 14 shown in FIG. 1, but these are omitted from illustration in FIG. 5.

The curing layer 314 not only prevents scratches on the surface of the organic EL image display device 100 but also prevents warping ascribable to the circular polarizing plate 301. An anti-reflection layer may be formed further on the curing layer 314. The organic EL element 101 itself has a thickness of about 1 μm.

In the configuration described above, when a voltage is applied to the metal electrode 112 and the transparent electrode 114, electrons and holes are injected into the light emission layer 113 from whichever of the metal electrode 112 and the transparent electrode 114 act as a cathode and an anode respectively. In the light emission layer 113, electrons and holes recombine to cause light emission of visible light corresponding to the light emission characteristics of the light emission layer 113. The light produced in the light emission layer 113 is directly, or after being reflected on the metal electrode 112, extracted via the transparent electrode 114 and the circular polarizing plate 301.

Here, linearly polarized light that has passed through the polarizer 311 of the circular polarizing plate 301 is converted into circularly polarized light or elliptically polarized light by the quarter-wave film 313; thus, no matter from what angle a viewer wearing polarized sun glasses views the image displayed on the organic EL image display device 100, light components parallel to the transmission axis of the polarized sun glasses can be directed to the viewer's eyes to permit him to view the displayed image.

Incidentally, in general, in an organic EL image display device, on a transparent substrate, a metal electrode, a light emission layer, and a transparent electrode are stacked in this order to form an element (organic EL element) as a light-emitting body. Here, the light emission layer is a stack of various organic thin films, and as such stacks, various combinations are known, examples including a stack of a hole injection layer of a triphenylamine derivative or the like and a light emission layer of a fluorescent organic solid such as anthracene, a stack of such a light emission layer and an electron injection layer of a perylene derivative or the like, and a stack of such a hole injection layer, a light emission layer, and an electron injection layer.

An organic EL image display device emits light according to the following principle: applying a voltage to the transparent electrode and the metal electrode causes holes and electrons to be injected into the light emission layer; the energy produced as the holes and the electrons recombine excites a fluorescent substance; the excited fluorescent substance radiates light while returning to the ground state. Here, the mechanism of recombination is the same as in common diodes, and as will be expected from this fact, the current and the light emission intensity exhibit, with respect to the applied voltage, a marked non-linearity accompanied by a rectifying property.

In an organic EL image display device, to allow extraction of light from the light emission layer, at least one electrode needs to be transparent, and typically a transparent electrode formed of a transparent electrically conductive material such as indium tin oxide (ITO) is used for the anode. On the other hand, to facilitate electron injection and increase light emission efficiency, it is advisable to use for the cathode a substance with a small work function, and typically a metal electrode of Mg—Ag, Al—Li, or the like is used.

In an organic EL image display device configured as described above, the light emission layer is formed as a very thin film with a thickness of about 10 nm. Thus, the light emission layer, like the transparent electrode, almost fully transmits light. As a result, when no light is being emitted, the light that enters through the front side of the transparent substrate is transmitted through the transparent electrode and the light emission layer and is then reflected from the metal electrode to exit back to the front side of the transparent substrate. Thus, when viewed from the outside, the display surface of the organic EL image display device appears to be a mirror surface.

A circular polarizing plate according to the embodiment is suitable in an organic EL image display device where such reflection of external light poses a problem.

Specifically, when the organic EL element 101 is not emitting light, the external light, such as of indoor lighting, that enters the organic EL element 101 is half absorbed by the polarizer 311 of the circular polarizing plate 301, and is half transmitted as linearly polarized light to enter the optical film 316. The light that has entered the optical film 316 is, by being transmitted through the optical film 316, converted into circularly polarized light owing to the polarizer 311 and the optical film 316 being arranged such that the transmission axis of the former and the slow axis of the latter intersect at 45° (or 135°).

The circularly polarized light that has exited from the optical film 316 is, when specularly reflected on the metal electrode 112 of the organic EL element 101, converted to have a 180 degrees inverted phase, and is thus reflected as circularly polarized light of the opposite rotation. The reflected light is, by entering the optical film 316, converted into linearly polarized light perpendicular to the transmission axis (parallel to the absorption axis) of the polarizer 311, and is thus totally absorbed by the polarizer 311 so as not to emerge outside. Thus, the circular polarizing plate 301 can reduce reflection of external light on the organic EL element 101.

### Practical Examples

Hereinafter, practical examples of polarizing plates according to the embodiment will be described specifically, in comparison with comparative examples. These examples, however, are not meat to limit the present invention. In the following description, the notations “part(s)” and “%” mean “part(s) by mass” and “% by mass” respectively unless otherwise indicated.

<Production of a Long Film>

Long films A to C were produced in the following manners respectively.

(Long Film A)

Long film A is a polycarbonate-based resin film (PC), and was produced in the following manner.

<<Dope Composition>>

| | | |
|---|---|---|
| Polycarbonate Resin (with a viscosity-average | 100 | parts by mass |
| molecular weight of 40000, bisphenol A-type) | | |
| 2-(2′-hydroxy-3′,5′-di-t- | 1.0 | parts by mass |
| butylphenyl)benzotriazol | | |
| Methylene Chloride | 430 | parts by mass |
| Methanol | 90 | parts by mass |

These were put in a hermetic container, and were stirred until complete dissolution while being kept at 80° C. under pressure to obtain a dope composition.

Subsequently, the dope composition was filtered, was cooled to be kept at 33° C., was flow-cast onto a stainless steel band, and was dried for 5 minutes at 33° C. Thereafter, the period of drying at 65° C. was adjusted such that the retardation was 5 nm, the cast film was released from the stainless steel band, and the drying was completed while the film was transported on a number of rolls to obtain long film A, which had a film thickness of 85 μm, a width of 1000 nm, and a photoelastic coefficient of 2.5×10⁻¹¹ (Pa⁻¹).

(Long Film B)

Long film B was a cycloolefin-based resin film (COP), and was produced in the following manner.

In a nitrogen atmosphere, 500 parts by mass of dehydrated cyclohexane was mixed with 1.2 parts by mass of 1-hexene, 0.15 parts by mass of dibutylether, and 0.30 parts by mass of triisobutylaluminum in a reactor vessel at room temperature. Then, while the mixture was kept at 45° C., a norbornene monomer mixture composed of 20 parts by mass of tricyclo[4.3.0.12,5]deca-3,7-diene (dicyclopentadiene, hereinafter abbreviated to DCP), 140 parts by mass of 1,4-methano-1,4,4a,9a-tetrahydrofluorene (hereinafter abbreviated to MTF), and 40 parts by mass of 8-methyl-tetracyclo[4.4.0.12,5.17,10]-dodeca-3-ene (hereinafter abbreviated to MTD) as well as 40 parts by mass of tungsten hexachloride (a 0.7% solution in toluene) were added to the solution continuously for two hours to achieve polymerization. To the polymerized solution, 1.06 parts by mass of butyl glycidyl ether and 0.52 parts by mass of isopropyl alcohol were added to inactivate the polymerization catalyst and stop the polymerization reaction.

Next, to 100 parts by mass of the obtained reaction solution containing an open-ring polymer, 270 parts by mass of cyclohexane was added, and moreover, as a hydrogenation catalyst, 5 parts by mass of nickel-alumina catalyst (manufactured by Nikki Chemicals Co.) was added. Then, under application of a pressure of 5 MPa with hydrogen accompanied by stirring, the mixture was heated up to 200° C. and subjected to a reaction for four hours to obtain a reaction solution containing 20% of a hydrogenated polymer of DCP/MTF/MTD open ring polymers.

After removal of the hydrogenation catalyst by filtration, a soft polymer (SEPTON 2002 manufactured by Kuraray Co., Ltd.) and an antioxidant (IRGANOX 1010 manufactured by Ciba Specialty Chemicals plc.) were added to and dissolved in the obtained solution (0.1 parts by mass of each in 100 parts by mass of the polymer). Next, cyclohexane as the solvent and other volatile components were removed from the solution by use of a cylindrical concentration dryer (manufactured by Hitachi Ltd.), and the hydrogenated polymer in a melted state was extruded from an extruder in the form of a strand, and was, after cooling, pelletized and collected. The copolymerization ratio of the respective norbornene monomers in the polymer was calculated based on the composition of the residual norbornene species in the solution after polymerization (by gas chromatography), and the result, DCP/MTF/MTD=10/70/20, was approximately equal to the charged composition. The obtained hydrogenated polymer of open-ring polymers had a weight-average molecular weight (Mw) of 31,000, a molecular weight distribution (Mw/Mn) of 2.5, a hydrogenation ratio of 99.9%, and a Tg of 134° C.

The obtained pellets of the hydrogenated polymer of open-ring polymers were dried for two hours at 70° C. by use of a hot wind drier through which air was circulated, to remove moisture. Next, the pellets were subjected to melt extrusion molding on a single-axis extruder (manufactured by Mitsubishi Heavy Industry Co., Ltd., with a screw diameter of 90 mm, with a T die rip part formed of tungsten carbide, and with a release strength of 44 N with respect to the melted resin) having a coat hanger-type T die to prepare a cycloolefin polymer film with a thickness of 75 μm. Extrusion molding was performed in a clean room of class 10,000 or less, under the molding conditions of a melted resin temperature of 240° C. and a T-die temperature of 240° C., so as to obtain long film B, which had a width of 1000 mm and a photoelastic coefficient of 5.0×10⁻¹² (Pa⁻¹).

(Long Film C)

Long film C is a cellulose ester-based rein film, and was produced in the following manner.

<<Fine Particle-Dispersed Liquid>>

| | |
|---|---|
| Fine Particles (Aerosil R927V manufactured by | 11 parts by mass |
| Nippon Aerosil Co., Ltd.) | |
| Ethanol | 89 parts by mass |

These were stirred and mixed for 50 minutes in a dissolver, and then dispersion was performed by a Munton Gorlin process.

<<Fine Particle-Containing Liquid>>

Based on the composition shown below, the above fine particle-dispersed liquid was added slowly into a dissolution tank containing methylene chloride under sufficient stirring. Then, dispersion was performed with an attritor such that the secondary particles had a predetermined size. The product was filtered with a FINEMET NF manufactured by Nippon Seisen Co., Ltd., and thus a fine particle-containing liquid was prepared.

| | |
|---|---|
| Methylene chloride | 99 parts by mass |
| Fine particle-dispersed liquid 1 | 5 parts by mass |

<<Main Dope Liquid>>

A main dope liquid of the composition shown below was prepared. Specifically, first, methylene chloride and ethanol were added into a pressurized dissolution tank. Then, cellulose acetate was added into the pressurized dissolution tank containing the solvent under stirring. The solution was heated, stirred to complete dissolution, and filtered by use of Azumi filter paper No. 244 manufactured by Azumi Filter Paper Co., Ltd., and thus the main dope liquid was prepared. As a sugar ester compound and an ester compound, those synthesized according to an example of synthesis noted below were used.

<<Composition of Main Dope Liquid>>

| | | |
|---|---|---|
| Methylene chloride | 340 | parts by mass |
| Ethanol | 64 | parts by mass |
| Cellulose acetate propionate (with degrees of | 100 | parts by mass |
| substitution by acetyl group 1.50 and by propio- | | |
| nyl group 0.90, the total degree of substitution | | |
| 2.40) | | |
| Sugar ester compound | 5.0 | parts by mass |
| Ester compound | 5.0 | parts by mass |
| Fine Particle-Containing Liquid 1 | 1 | parts by mass |

<Synthesis of Sugar Ester Compound>>

A sugar ester compound was synthesized through the following process.

[Chemical Formula 19]

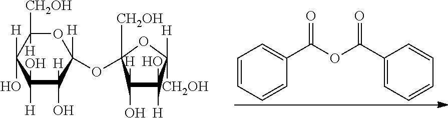

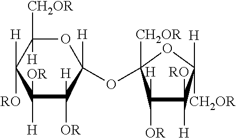

| | R (Number of Substitutions) | |
|---|---|---|
| Exemplary Compound A-1 | —H (0) | 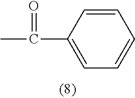 |
| Exemplary Compound A-2 | —H (1) | 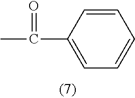 |
| Exemplary Compound A-3 | —H (2) | 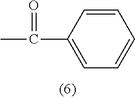 |
| Exemplary Compound A-4 | —H (3) | 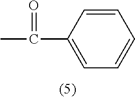 |
| Exemplary Compound A-5 | —H (4) | 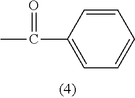 |

A four-necked flask provided with a stirring device, a reflux condenser, a thermometer, and a nitrogen gas introduction pipe was charged with 34.2 g (0.1 mol) of sucrose, 180.8 g (0.6 mol) of benzoic anhydride, and 379.7 g (4.8 mol) of pyridine. Under stirring, with nitrogen gas bubbling from the nitrogen gas introduction pipe, temperature was raised, and an esterification reaction was performed for five hours at 70° C.

Next, the interior of the flask was depressurized down to 4×10² Pa or less, and excess pyridine was distilled away at 60° C.; then the interior of the flask was depressurized down to 1.3×10 Pa or less and heated up to 120° C., and the greater part of the benzoic anhydride and of the benzoic acid produced was distilled away.

Lastly, 100 g of water was added to the isolated toluene layer, which was then washed with the water for 30 minutes at room temperature; then the toluene layer was isolated, and the toluene was distilled away under reduced pressure (4×10² Pa or less), at 60° C. Thus, a mixture of compounds A-1, A-2, A-3, A-4, and A-5 (sugar ester compounds) were obtained.

The obtained mixture was analyzed by HPLC and LC-MASS, and it was found that the content of A-1 was 1.3% by mass, the content of A-2 was 13.4% by mass, the content of A-3 was 13.1% by mass, the content of A-4 was 31.7% by mass, and the content of A-5 was 40.5% by mass. The average degree of substitution was 5.5.

<<Measurement Conditions for HPLC-MS>>

1) LC Part

Equipment: a column oven (JASCO CO-965), a detector (JASCO UV-970-240 nm), a pump (JASCO PU-980), a degasser (JASCO DG-980-50), all manufactured by JASCO Corporation.

Column: Inertsil ODS-3, particle diameter 5 μm, 4.6×250 mm (manufactured by GL Sciences Inc.)

Column Temperature: 40° C.

Flow Rate: 1 ml/minute

Movement Phase: TFH (1% acetic acid):H₂O (50:50)

Injected Volume: 3 μl

2) MS Part

Equipment: an LCQ DECA (manufactured by Thermo Quest Inc.)

Ionization Method: Electrospray Ionization (ESI)

Spray Voltage: 5 kV

Capillary Temperature: 180° C.

Vaporizer Temperature: 450° C.

<<Synthesis of Ester Compounds>>

An ester compound was synthesized through the following process.

A 2 L four-necked flask provided with a thermometer, a stirrer, and a bulb condenser was charged with 251 g of 1,2-propylene glycol, 278 g of phthalic anhydride, 91 g of adipic acid, 610 g of benzoic acid, and 0.191 g of tetraisopropyl titanate as an esterization catalyst, and the mixture was heated gradually under stirring in a stream of gaseous nitrogen until the temperature reached 230° C. A dehydration condensation reaction was performed for 15 hours, and after the completion of the reaction, unreacted 1,2-propylene glycol was distilled away at 200° C. under reduced pressure. Thus, an ester compound was obtained. The ester compound had an ester of benzoic acid at an end of a polyester chain formed by condensation of 1,2-propylene glycol, phthalic anhydride, and adipic acid. The ester compound had an acid number of 0.10 and a number average molecular weight of 450.

Next, on an endless belt flow casting machine, the dope liquid was evenly flow-cast on a stainless steel belt support member.

On the endless belt flow casting machine, the main dope liquid described above was evenly flow-cast on the stainless steel belt support member. On the stainless steel belt support member, the solvent was evaporated until the residual amount of solvent in the flow-cast film was 75%; then the cast film was released from the stainless steel belt support member, and drying was completed while the film was transported on a number of rolls to obtain long film C with a width of 1000 mm. The long film C had a film thickness of 100 μm and a photoelastic coefficient of 2.0×10⁻¹² (Pa⁻¹)^{.}

The photoelastic coefficients of long films A to C were measured through the following procedure.

Long films A to C obtained were each cut into a sample sized 30 mm×50 mm. On a cell gap tester (RETS-1200, with a measurement diameter of 5 mm and a light source of 589 nm) manufactured by Otsuka Electronics Co., LTD., the sample, with a film thickness of d (nm), was nipped between holding members, and was subjected to a stress σ (Pa) of 9.81×10⁶ acting in the length direction. Under the stress, the phase difference R1 (nm) was measured. Let the phase difference before the application of the stress be R0 (nm), and the relevant values were substituted in the formula below to calculate the photoelastic coefficient Cσ (Pa⁻¹).

Cσ(Pa⁻¹)=(R1−R0)/(σ×d)

### Practical Example 1

### Production of Quarter-Wave Film

On the production apparatus shown in FIG. 3, long film C was stretched such that the orientation angle θ was 45° to produce a long obliquely stretched film as a quarter-wave film. The long film was transported at a transport speed of 25 m/min. The long obliquely stretched film discharged from the stretching device was subjected to end-portion trimming to adjust the eventual film width of the obliquely stretched film. The quarter-wave film had a film thickness of 30 μm and an Ro of 138 nm.

[Production of Protective Film]

An acrylic resin having a lactone ring unit as described below was prepared. Specifically, according to Production Example 1 described in paragraphs [0222] to [0224] in JP-A-2008-9378, through synthesis of 7500 g of methyl methacrylate and 2500 g of methyl 2-(hydroxymethyl)acrylate, an acrylic resin with a degree of lactonization of 98% and a Tg of 134° C. was obtained.

The prepared acrylic resin was dried at 90° C. on a vacuum dryer such that it had a moisture content of 0.03% or less, and was then mixed with 0.3% by weight of a stabilizer (IRGANOX 1010 manufactured by Ciba-Geigy Japan Limited); then, on a two-axis kneader/extruder with a vent, at 230° C. and in a stream of nitrogen, the mixture was extruded into water so as to be formed into a strand, which was then cut into pellets with a diameter of 3 mm and a length of 5 mm.

The pellets were dried at 90° C. on a vacuum dryer such that it had a moisture content of 0.03% or less, and were then kneaded and extruded on a single-axis kneader/extruder, at 210° C. in a feeder portion, 230° C. in a compression portion, and 230° C. in a measurement portion. Here, between the extruder and the die, a 300 mesh screen filter, a gear pump, and a leaf disc filter with a filtering accuracy of 7 μm were arranged in this order, coupled together by melt piping. Moreover, a static mixer was arranged immediately upstream of the die, inside the melt piping. The difference in temperature between at both ends and at the center of the die, the difference between the die lip temperature and the die temperature, and the C/T ratio were controlled to fulfill predetermined conditions.

Thereafter, the melt (melted resin) was extruded onto triple cast rolls. Here, with the most upstream cast roll (chill roll), a touch roll was kept in contact under a predetermined contact pressure. Used as the touch roll is the one described as Practical Example 1 in JP-A-H11-235747 (the one mentioned as a double-holding roll, but with the thin metallic outer cylinder given a thickness of 2 mm here), at a predetermined touch pressure and at a predetermined touch temperature. The temperatures at the triple cast rolls including the chill roll were respectively, from up to downstream, (touch roll temperature)+3° C., (touch roll temperature)−2° C., and (touch roll temperature)−7° C.

Thereafter, immediately before being wound up, the film was trimmed at both ends (about 5 cm of the total width at each end), and were subjected to thickening (knurling) at both ends, for a height of 20 μm over a width of 10 mm at each end. The film was formed to have a width of 1.5 m, and 3000 m of it was formed and wound up at a speed of 30 m/min.

[Production of Polarizer]

100 parts by mass of polyvinyl alcohol (PVA) with a degree of saponification of 99.95% by mol and a degree of polymerization of 2400 was impregnated with 10 parts by mass of glycerine and 170 parts by mass of water, and was melted and kneaded. After defoaming, the melt is melt-extruded from a T die onto a metal roll to form a film. The film was then dried and heat-treated to produce a PVA film. The obtained PVA film had an average thickness of 25 μm, a moisture content of 4.4%, and a film width of 3 m.

Next, the obtained PVA film was subjected to, continuously in the order named, the processes of preliminary swelling, dyeing, uniaxial extension by a wet process, fixing, drying, and heat treatment to produce a polarizing layer (polarizer).

Specifically, the film was preliminarily swollen by being immersed in water at 30° C. for 30 seconds, and was then immersed in a water solution with an iodine concentration of 0.4 g/L and a potassium iodide concentration of 40 g/L at 35° C. for 3 minutes. Subsequently, under the condition where the film was exposed to a tension of 700 N/m in a water solution of boric acid at a concentration of 4% at 50° C., the film was uniaxially extended by a factor of 6. Then the film was fixed by being immersed for 5 minutes in a water solution, at 30° C., of potassium iodide at a concentration of 40 g/L, boric acid at a concentration of 40 g/L, and zinc chloride at a concentration of 10 g/L.

Thereafter, the PVA film was taken out, was dried in hot air at 40° C., and was heat-treated at 100° C. for 5 minutes. The obtained polarizing layer had an average thickness of 18 μm and, as for polarizing characteristics, a transmittance of 43.0%, a degree of polarization of 99.5%, and a dichroic rate of 40.1.

[Bonding of Film to Polarizer]

Through steps 1 to 4 described below, the quarter-wave film was bonded to the obverse face of the polarizer, and the protective film was bonded to the reverse face of the polarizer.

(Step 1)

The polarizer described above was immersed for 1 to 2 seconds in a reservoir containing a solution of polyvinyl alcohol adhesive with a solid content of 2% by mass.

(Step 2)

The quarter-wave film was subjected to alkali treatment under the following conditions:

| | | | |
|---|---|---|---|
| Saponification | KOH, 2.5 mol/L | 50° C. | 120 Seconds |
| Water Washing | Water | 30° C. | 60 Seconds |
| Neutralization | HCl, 10 Parts by Mass | 30° C. | 45 Seconds |
| Water Washing | Water | 30° C. | 60 Seconds |

After saponification, water washing, neutralization, and water washing were performed in this order, followed by drying at 100° C.

Subsequently, the polarizer was immersed in the solution of polyvinyl alcohol adhesive used in Step 1. The excess adhesive on the immersed polarizer was removed lightly, and then the polarizer was put between the quarter-wave film and the protective film, and these were stacked together.

(Step 3)

The stacked films were bonded together by two rotating rollers, under a pressure of 20 to 30 N/cm² and at a speed of about 2 m/min. Meanwhile, care was taken so that no bubbles were introduced.

(Step 4)

The sample produced in Step 3 was dried at 100° C. for 5 minutes in a dryer to obtain a stack in the form of a roll.

[Formation of Hard-Coat Layer]

A hard coat composition described below was filtered by a filter made of polypropylene with a pore diameter of 0.4 μm, and with the filtrate, the quarter-wave film described above was coated on an extrusion coater. The coated film was dried at 80° C. in the constant-rate drying period and at 80° C. in the decreasing-rate drying period, and then, while nitrogen purging was performed to maintain an environment with an oxygen concentration of 1.0% or less by volume, the coating layer was cured by use of an ultraviolet-ray lamp, with the irradiance in the irradiated part at 100 mW/cm² and the amount of irradiation at 0.23 J/cm². Thus, a hard-coat layer (curing layer) with a dry film thickness of 7.5 μm was obtained.

(Hard Coat Composition)

<<Resin>>

| | |
|---|---|
| Pentaerythritol tri/tetraacrylate (NK Ester A-TMM- | 30 parts by mass |
| 3L, manufactured by Shin-Nakamura Chemical Co., | |
| Ltd.) | |
| An active energy ray-curable isocyanurate deriva- | 35 parts by mass |
| tive: tris(2-acryloyloxyethyl)isocyanurate (NK Ester | |
| A-9300, manufactured by Shin-Nakamura Chemical | |
| Co., Ltd.) | |
| A group A active energy-ray resin: N-acryloyloxy- | 35 parts by mass |
| ethylhexahydrophthalimide (Aronix M-140, manufac- | |
| tured by TOAGOSEI Co., Ltd.) | |

<<Photopolymerization Initiator>>

| | |
|---|---|
| IRGACURE 184 (manufactured by BASF Japan Ltd.)) | 5 parts by mass |

<<Additive>>

| | |
|---|---|
| A polydimethylsiloxiane having a polyether- | 1 parts by mass |
| modified acrylic group: BYK-UV3510 (manufactured by | |
| BYK-Chemie GmbH). | |

<<Solvent>>

| | |
|---|---|
| Propyleneglycol monomethyl ether | 15 parts by mass |
| Methyl acetate | 25 parts by mass |
| Methylethyl ketone | 60 parts by mass |

<<Ultraviolet Ray Absorber>>

| | |
|---|---|
| TINUVIN 928 (manufactured by BASF Japan Ltd.) | 12 parts by mass |

As described above, on one face of a polarizer, via an adhesive layer (PVA adhesive (water glue)), a quarter-wave film and a curing layer containing an organic UV absorber were formed, and on the other face of the polarizer, a protective film was formed; thus, a polarizing plate of Practical Example 1 was is produced. In Practical Example 1, the quarter-wave film had a thickness of 30 μm, and the adhesive layer had a thickness of 0.02 μm.

### Practical Example 2

In Practical Example 2, the quarter-wave film and the protective film were bonded to the polarizer with ultraviolet ray-curable adhesive (UV adhesive); otherwise, a polarizing plate was produced in a similar manner as in Practical Example 1.

[Preparation of Ultraviolet Ray-Curable Adhesive 1]

The components noted below were mixed, and the mixture was then defoamed to prepare ultraviolet ray-curable adhesive liquid 1. As for triarylsulfonium hexafluorophosphate, it was blended as a 50% solution in propylene carbonate, and the amount listed below is that of the solid component of triarylsulfonium hexafluorophosphate.

| | | |
|---|---|---|
| 3,4-epoxycyclohexylmethyl-3,4- | 45 | parts by mass |
| epoxycyclohexanecarboxylate | | |
| EPOLEAD GP-301 (an alicyclic epoxy | 40 | parts by mass |
| resin manufactured by Daicel Chemical | | |
| Industries, Ltd.) | | |
| 1,4-butanediol diglycidyl ether | 15 | parts by mass |
| triarylsulfonium hexafluorophosphate | 2.3 | parts by mass |
| 9.10-dibutoxyanthracene | 0.1 | parts by mass |
| 1,4-diethoxynaphthalene | 2.0 | parts by mass |

<<Production of Polarizing Plate>>

First, the surface of the quarter-wave film was treated by corona discharge. Corona charge treatment was performed under the following conditions: corona output intensity, 2.0 kW; line speed, 18 m/min. Subsequently, over the corona discharge-treated surface of the quarter-wave film, ultraviolet ray-curable adhesive liquid 1 prepared as described above was applied on a bar coater such that the film thickness after curing would be about 2 μm. Thus, a UV adhesive layer 1 was formed. Then, to the obtained UV adhesive layer 1, the polarizer (with a thickness of 18 μm) was bonded.

Next, the surface of the protective film was treated by corona discharge. Corona charge treatment was performed under the following conditions: corona output intensity, 2.0 kW; line speed, 18 m/min. Subsequently, over the corona discharge-treated surface of the protective film, ultraviolet ray-curable adhesive liquid 1 prepared as described above was applied on a bar coater such that the film thickness after curing would be about 2 μm. Thus, a UV adhesive layer 2 was formed.

Then, to the face of the polarizer opposite from the quarter-wave film, via the UV adhesive layer 2, the protective film was bonded. Thus, a stack composed of a quarter-wave film, a UV adhesive layer 1, a polarizer, a UV adhesive layer 2, and a protective film was obtained. Here, the protective film and the polarizer were bonded together such that the slow axis of the former and the absorption axis of the latter form an angle of 45°.

The stack was then irradiated, on both faces, with ultraviolet rays on an ultraviolet-ray irradiating device equipped with a belt conveyor (used as a lamp was a D bulb manufactured by Fusion UV Systems Inc.) such that the cumulative amount of light was 750 mJ/cm², and thereby the UV adhesive layers 1 and 2 were cured. Thereafter, as in Practical Example 1, a curing layer was formed on the surface of the quarter-wave film, and thus a polarizing plate was produced.

### Practical Example 3

In Practical Example 3, the UV adhesion between the polarizer and the quarter-wave film and between the polarizer and the protective film was achieved by a technique similar to that of Example 1 in WO2012/086465; otherwise a polarizing plate was produced in a similar manner as in Practical Example 2, specifically in the following manner.

(Active Energy Rays)

As active energy rays, ultraviolet rays were used (a gallium-sealed metal halide lamp) (radiating device: Light HAMMER 10, manufactured by Fusion UV Systems, Inc.; valve: V valve; peak irradiance: 1600 mW/cm²; and cumulative amount of irradiation: 1000/mJ/cm² (wavelength: 380 to 440 nm)). The irradiance of the ultraviolet rays was measured using a Sola-Check system manufactured by Solatell Ltd.

(Preparation of Active Energy Ray-Curable Adhesive Composition)

The components below were mixed, and the mixture was stirred at 50° C. for 1 hour to obtain an active energy ray-curable adhesive composition.

| | | |
|---|---|---|
| (1) Radical-Polymerizable Compound | 38.3 | parts by mass |
| HEAA (hydroxyethyl acrylamide), | | |
| manufactured by Kohjin Co., Ltd. | | |
| (2) Radical-Polymerizable Compound | 19.1 | parts by mass |
| ARONIX M-220 (tripropyleneglycol | | |
| diacrylate), manufactured by | | |
| TOAGOSEI Co., Ltd.) | | |
| (3) Radical-Polymerizable Compound | 38.3 | parts by mass |
| ACMO (acryloyl morpholine), | | |
| manufactured by Kohjin Co., Ltd. | | |
| (4) Photopolymerization Initiator | 1.4 | parts by mass |
| KAYACURE DETX-S (diethyl thioxanthone), | | |
| manufactured by Nippon Kayaku Co., Ltd.) | | |
| IRGACURE 907 (2-methyl-1-(4-methylthio- | 1.4 | parts by mass |
| phenyl)-2-morpholinopropane-1-on), manu- | | |
| factured by BASF Japan Ltd.) | | |

Next, over the quarter-wave film and over the protective film, the active energy ray-curable adhesive composition described above was applied with a thickness of 0.5 μm on an MCD coater (manufactured by Fuji Machine Mfg. Co., Ltd.) (cell shape: honeycomb; gravure roll line number: 1000 lines/inch; rotation speed: 140% of line speed). The quarter-wave film and the protective film were then bonded to the opposite faces, respectively, of the polarizer on a roll machine. Thereafter, from both sides (the quarter-wave film-side and the protective film-side) of the polarizer, it was heated to 50° C. by use of an IR heater; it was then irradiated, on both faces, with the ultraviolet rays described above so that the active energy ray-curable adhesive composition described above was cured, and was then dried at 70° C. for 3 minutes. Thus, a polarizing plate was obtained. The line speed during bonding was 25 m/min.

### Practical Example 4

In Practical Example 4, a polarizing plate was produced with the thickness of the quarter-wave film reduced from 18 μm to 12 μm. Otherwise this example was similar to Practical Example 1.

### Practical Example 5

In Practical Example 5, a polarizing plate was produced with the thickness of the quarter-wave film further reduced from 18 μm to 5 μm. Otherwise this example was similar to Practical Example 1.

### Practical Example 6

In Practical Example 6, long film A, which is a polycarbonate-based film, was obliquely stretched to produce a quarter-wave film, and by use of this quarter-wave film, a polarizing plate was produced. Otherwise this example was similar to Practical Example 2. The quarter-wave film had a film thickness of 30 μm and an Ro of 120 nm.

### Practical Example 7

In Practical Example 7, long film B, which is a cycloolefin-based film, was obliquely stretched to produce a quarter-wave film, and by use of this quarter-wave film, a polarizing plate was produced. Otherwise this example was similar to Practical Example 2. The quarter-wave film had a film thickness of 30 μm and an Ro of 90 nm.

### Practical Example 8

In Practical Example 8, a polarizing plate was produced with the same ultraviolet ray absorber as contained in the curing layer added to the quarter-wave film. Otherwise this example was similar to Practical Example 1. The quarter-wave film had a film thickness of 30 μm and an Ro of 138 nm.

### Practical Example 9

In Practical Example 9, a polarizing plate was produced by use of, as an additive contained in the curing layer, instead of BYK-UV3510, BYK-381 (manufactured by BYK-Chemie GmbH), which is an acrylic-based surfactant (surface-adjusting agent). In this polarizing plate, the quarter-wave film had a film thickness of 20 μm and an Ro of 80 nm, and the polarizer had a thickness of 12 μm. Otherwise, this example was similar to Practical Example 3.

### Practical Example 10

In Practical Example 10, a polarizing plate was produced by use of, as an additive contained in the curing layer, instead of BYK-381, Surfynol 104PG-50 (manufactured by Nissin Chemical Co., Ltd.). Otherwise, this example was similar to Practical Example 9. Also in this practical example, the quarter-wave film had a film thickness of 20 μm and an Ro of 80 nm.

### Practical Example 11

In Practical Example 11, a polarizing plate was produced with an overcoat layer as a functional layer formed on top of the curing layer. Otherwise this example was similar to Practical Example 9. The overcoat layer contained the same components as the curing layer in Practical Example 1 excluding the ultraviolet ray absorber Tinuvin 928, and was applied on top of the curing layer such that its thickness after drying would be 2 μm. As an additive to both the curing layer and the overcoat layer, a silicone-based surfactant KF-351 (manufactured by Shin-Etsu Chemical Co., Ltd.) was used. Also in this practical example, the quarter-wave film had a film thickness of 20 μm and an Ro of 80 nm.

### Practical Example 12

In Practical Example 12, a polarizing plate was produced by using, as an additive to the overcoat layer, instead of KF-351, BYK-381. Otherwise this example was similar to Practical Example 11. Also in this practical example, the quarter-wave film had a film thickness of 20 μm and an Ro of 80 nm.

### Practical Example 13

In Practical Example 13, a polarizing plate was produced by using, as an additive to the overcoat layer, instead of KF-351, Surfynol 104PG-50 (manufactured by Nissin Chemical Co., Ltd.). Otherwise this example was similar to Practical Example 11. Also in this practical example, the quarter-wave film had a film thickness of 20 μm and an Ro of 80 nm.

### Comparative Example 1

In Comparative Example 1, the quarter-wave film was a thick film with a thickness of 80 μm as in Patent Document 1, and the ultraviolet ray absorber (an organic compound), which was otherwise contained in the curing layer, was here contained in the thick-film quarter-wave film. Otherwise a polarizing plate was produced in a similar manner as in Practical Example 1. The quarter-wave film had an Ro of 138 nm.

### Comparative Example 2

In Comparative Example 2, long film B, which was a cycloolefin resin film, was obliquely stretched to produce a thick-film quarter-wave film with a thickness of 80 μm, and this quarter-wave film was bonded to the polarizer via a sticking layer of acrylic-based sticking agent with a thickness of 10 μm. Moreover, the curing layer contained, as an ultraviolet ray absorber, inorganic fine particles (here, titanium oxide). Otherwise a polarizing plate was produced in a similar manner as in Practical Example 1. The quarter-wave film had an Ro of 138 nm.

### Comparative Example 3

In Comparative Example 3, a polarizing plate was produced by use of, instead of a thick-film quarter-wave film, a thin-film quarter-wave film with a thickness of 30 μm. Otherwise this example was similar to Comparative Example 2. The quarter-wave film had an Ro of 138 nm.

### Comparative Example 4

In Comparative Example 4, the quarter-wave film was bonded to the polarizer via, instead of a sticking layer, an adhesive layer of PVA (with a thickness of 0.02 μm). Otherwise a polarizing plate was produced in a similar manner as in Comparative Example 2.

### Comparative Example 5

In Comparative Example 5, a polarizing plate was produced by use of, instead of a thick-film quarter-wave film, a thin-film quarter-wave film with a thickness of 30 μm. Otherwise this example was similar to Comparative Example 4. The quarter-wave film had an Ro of 138 nm.

### Comparative Example 6

In Comparative Example 6, a polarizing plate was produced with no inorganic fine particles capable of absorbing ultraviolet rays contained in the curing layer. Otherwise this example was similar to Comparative Example 5.

### Comparative Example 7

In Comparative Example 7, long film A, which was a polycarbonate-based resin film, was obliquely stretched to produce a thin-film quarter-wave film with a thickness of 35 μm, and by use of this thin-film quarter-wave film, a polarizing plate was produced. Otherwise this example was similar to Comparative Example 1. The quarter-wave film had an Ro of 138 nm.

<Production of Liquid Crystal Display Device and Durability Tests>

From a commercially available liquid crystal device, an originally bonded viewer-side polarizing plate was removed, and instead each of the polarizing plates produced as described above was bonded on the substrate surface of a liquid crystal cell, and thus a liquid crystal display device was produced. Here, the polarizing plate was bonded such that its absorption axis pointed in the same direction as the originally bonded one. Twenty such liquid crystal display devices were produced as samples for each of the practical and comparative examples described previously. These liquid crystal display devices were subjected to durability tests, in which they were first left to stay in an environment of 60° C., 95% RH for 500 hours and then visibility was evaluated in a central and a peripheral part of the screen, by use of a polarizing microscope, based on the following criteria:

(Criteria for Evaluation)

Excellent: Increased peripheral brightness (degraded visibility) was observed in none out of 20 samples.

Good: Increased peripheral brightness (degraded visibility) was observed in one to two out of 20 samples.

Poor: Increased peripheral brightness (degraded visibility) was observed in three or more out of 20 samples.

If the curing layer in the polarizing plate separates from the quarter-wave film, or a crack develops in the quarter-wave film, when a viewer wearing polarized sun glasses views the displayed image, increased peripheral brightness degrades visibility. This makes it possible to evaluate visibility based on brightness.

When the curing layer separates from the quarter-wave film, a layer of air is produced between the curing layer and the quarter-wave film; thus reflection occurs at the interface between the curing layer and the layer of air and at the interface between the layer of air and the quarter-wave film. On the other hand, when a crack develops in the quarter-wave film, light is scattered at the crack. These are considered to be the causes of increased brightness observed, when the curing layer has separated or the quarter-wave film has developed a crack, in a peripheral part of the screen by a viewer viewing the displayed image through polarized sun glasses.

Table 1 shows the results of evaluation of visibility after durability tests with liquid crystal display devices employing the polarizing plates of Practical Examples 1 to 13 and Comparative Examples 1 to 7.

TABLE 1

| | | Practical | Practical | Practical | Practical |
|---|---|---|---|---|---|
| | | Example 1 | Example 2 | Example 3 | Example 4 |
| Polarizing Plate | HC Layer | Organic UV | Organic UV | Organic UV | Organic UV |
| Structure | Quarter-Wave | Thin-Film | Thin-Film | Thin-Film | Thin-Film |
| | Layer | | | | |
| | Adhesive Layer | Adhesive | Adhesive (UV) | Adhesive (UV) | Adhesive |
| | | (Water Glue) | | | (Water Glue) |
| | Polarizer | PVA | PVA | PVA | PVA |
| Quarter-Wave | Material | Cellulose | Cellulose | Cellulose | Cellulose |
| Layer | Thickness | 30 μm | 30 μm | 30 μm | 30 μm |
| Adhesive Layer Thickness | | 0.02 μm | 2 μm | 2 μm | 0.02 μm |
| Polarizer Thickness | | 18 μm | 18 μm | 18 μm | 12 μm |
| Visibility | | Good | Good | Good | Excellent |
| | | Practical | Practical | Practical | Practical |
| | | Example 5 | Example 6 | Example 7 | Example 8 |
| Polarizing Plate | HC Layer | Organic UV | Organic UV | Organic UV | Organic UV |
| Structure | Quarter-Wave | Thin-Film | Thin-Film | Thin-Film | Thin-Film |
| | Layer | | | | (Organic UV) |
| | Adhesive Layer | Adhesive | Adhesive (UV) | Adhesive (UV) | Adhesive |
| | | (Water Glue) | | | (Water Glue) |
| | Polarizer | PVA | PVA | PVA | PVA |
| Quarter-Wave | Material | Cellulose | PC | COP | Cellulose |
| Layer | Thickness | 30 μm | 30 μm | 30 μm | 30 μm |

| | | | | |
|---|---|---|---|---|
| Adhesive Layer Thickness | 0.02 μm | 2 μm | 2 μm | 0.02 μm |
| Polarizer Thickness | 5 μm | 18 μm | 18 μm | 18 μm |
| Visibility | Excellent | Good | Good | Good |

| | | Practical | Practical | Practical |
|---|---|---|---|---|
| | | Example 9 | Example 10 | Example 11 |
| Polarizing Plate | HC Layer | Organic UV | Organic UV | Organic UV |
| Structure | Quarter-Wave | Thin-Film | Thin-Film | Thin-Film |
| | Layer | | | |
| | Adhesive Layer | Adhesive (UV) | Adhesive (UV) | Adhesive (UV) |
| | Polarizer | PVA | PVA | PVA |
| Quarter-Wave | Material | Cellulose | Cellulose | Cellulose |
| Layer | Thickness | 20 μm | 20 μm | 20 μm |

| | | | |
|---|---|---|---|
| Adhesive Layer Thickness | 2 μm | 2 μm | 2 μm |
| Polarizer Thickness | 12 μm | 12 μm | 12 μm |
| Visibility | Excellent | Excellent | Excellent |

| | | Practical | Practical |
|---|---|---|---|
| | | Example 12 | Example 13 |
| Polarizing Plate | HC Layer | Organic UV | Organic UV |
| Structure | Quarter-Wave | Thin-Film | Thin-Film |
| | Layer | | |
| | Adhesive Layer | Adhesive (UV) | Adhesive (UV) |
| | Polarizer | PVA | PVA |
| Quarter-Wave | Material | Cellulose | Cellulose |
| Layer | Thickness | 20 μm | 20 μm |

| | | |
|---|---|---|
| Adhesive Layer Thickness | 2 μm | 2 μm |
| Polarizer Thickness | 12 μm | 12 μm |
| Visibility | Excellent | Excellent |

| | | Comparative | Comparative | Comparative | Comparative |
|---|---|---|---|---|---|
| | | Example 1 | Example 2 | Example 3 | Example 4 |
| Polarizing Plate | HC Layer | No Absorber | InorganicUV | InorganicUV | InorganicUV |
| Structure | Quarter-Wave | Thick-Film | Thick-Film | Thin-Film | Thick-Film |
| | Layer | (Organic UV) | | | |
| | Adhesive Layer | Adhesive | Sticking | Sticking | Adhesive |
| | | (Water Glue) | (Poor) | (Poor) | (Water Glue) |
| | Polarizer | PVA | PVA | PVA | PVA |
| Quarter-Wave | Material | Cellulose | COP | COP | COP |
| Layer | Thickness | 80 μm (Poor) | 80 μm (Poor) | 30 μm | 80 μm (Poor) |

| | | | | |
|---|---|---|---|---|
| Visibility | Good | Good | Good | Good |

| | | Comparative | Comparative | Comparative |
|---|---|---|---|---|
| | | Example 5 | Example 6 | Example 7 |
| Polarizing Plate | HC Layer | InorganicUV | No Absorber | No Absorber |
| Structure | Quarter-Wave | Thin-Film | Thin-Film | Thin-Film |
| | Layer | | | (Organic UV) |
| | Adhesive Layer | Adhesive | Adhesive | Adhesive |
| | | (Water Glue) | (Water Glue) | (Water Glue) |
| | Polarizer | PVA | PVA | PVA |
| Quarter-Wave | Material | COP | COP | PC |
| Layer | Thickness | 30 μm | 30 μm | 35 μm |

| | | | |
|---|---|---|---|
| Visibility | Poor(Due to | Poor(Due to | Poor(Due to |
| | Exfoliation) | Cracks) | Cracks) |

Practical Examples 1 to 13 exhibited suppressed degradation in visibility due to durability tests. The reasons are considered to be as follows. In a thin polarizing plate in which a thin-film quarter-wave film with a thickness of 70 μm or less is bonded to a polarizer via an adhesive layer, if a curing layer of an ultraviolet ray-curable resin contains an organic ultraviolet ray absorber, during curing by UV irradiation, the curing layer becomes softer at the side of the interface with the quarter-wave film than at the surface side; this reduces the stress on the quarter-wave film from the curing layer side during a durability test, making the quarter-wave film less likely to develop a crack. Moreover, even when the quarter-wave film contracts as the polarizer contracts during a durability test, the quarter-wave film side of the curing layer follows the contraction; this alleviates degradation in closeness of contact between the curing layer and the quarter-wave film, making the curing layer less likely to separate.

In particular, Practical Examples 4, 5, and 9 to 13, where the polarizer was thin, exhibited a notable effect of suppressing degradation in visibility due to durability tests. The reasons are considered to be as follows. With a thin polarizer, the quarter-wave film is subject to less stress as the polarizer contracts during a durability test, and this makes the quarter-wave film still less unlikely to develop a crack. Moreover, as the polarizer contracts, the quarter-wave film contracts less, and this makes the curing layer still less unlikely to separate.

While in all of Practical Examples 1 to 13, the polarizer had a thickness of 20 μm or less, visibility was evaluated as good with Practical Example 1, etc., where the polarizer had a thickness of 18 μm, and visibility was evaluated as excellent with Practical Example 4, where the polarizer had a thickness of 12 μm. From these results, it is expected that, with a polarizer with a thickness equal to or smaller than 15 μm, i.e., the mid value between 18 μm and 12 μm, visibility will be evaluated as excellent, the present invention providing a notable effect of suppressing degradation in visibility. Accordingly, from the viewpoint of suppressing degradation in visibility, the thickness of the polarizer is preferably 18 μm or less, and more preferably 15 μm or less.

On the other hand, using the polarizing plates of Comparative Examples 5 to 7 resulted in degraded visibility. The reasons are considered to be as follows. In the polarizing plate of Comparative Example 5, the curing layer contains, as an ultraviolet ray absorber, inorganic fine particles, which are thus present near the interface between the hard-coat layer and the quarter-wave film; this degrades the closeness of contact between those layers, making the hard-coat layer likely to separate during a durability test. In the polarizing plates of Comparative Examples 6 and 7, the curing layer contains no ultraviolet ray absorber, and thus the curing layer cannot be made softer near the interface with the quarter-wave film during UV irradiation; thus, during a durability test, not only stress from the polarizer side but also stress from the curing layer side acts on the quarter-wave film, developing a crack in it.

The polarizing plates of Comparative Examples 1 to 4 do not have the following feature presupposed in the present invention: a thin-film quarter-wave film is bonded to a polarizer via an adhesive layer. These examples are taken up to make it clear that the present invention addresses problems with thin-film polarizing plates. With structures that use a thick-film quarter-wave film with a film thickness of 80 μm or more as in Comparative Examples 1 to 4, and with structure where a polarizer and a quarter-wave film are bonded together via a sticking layer, no degradation in visibility as mentioned above was observed. The reasons are considered to be as follows.

With a thick-film quarter-wave film, the quarter-wave film itself is thick enough to withstand stress from the polarizer side and from the hard-coat layer side during a durability test, and is thus less likely to develop a crack. Moreover, with a thick-film quarter-wave film, even as the polarizer contracts during a durability test, the quarter-wave film contacts less easily, and thus the hard-coat layer is less likely to separate. On the other hand, with a structure where a polarizer and a quarter-wave film are bonded together via a sticking layer, the sticking layer absorbs the stress resulting from contraction of the polarizer during a durability test; this reduces the stress acting on the quarter-wave film, and makes the quarter-wave film less likely to develop a crack. Moreover, since the sticking layer is elastic, it absorbs contraction of the polarizer during a durability test, and thereby reduces contraction of the quarter-wave film; this makes the hard-coat layer less likely to separate (even when the hard-coat layer contains inorganic fine particles).

### INDUSTRIAL APPLICABILITY

Polarizing plates according to the present invention find applications in display devices such as liquid crystal display devices and organic EL display devices.

### LIST OF REFERENCE SIGNS

10 display device
11 display cell
12 polarizing plate
13 front window
14 filler
21 polarizer
22 adhesive layer
23 quarter-wave film
24 curing layer
27 overcoat layer

1. A polarizing plate comprising:
a quarter-wave film, and
a curing layer formed of an ultraviolet ray-curable resin stacked in this order at one face of a polarizer via an adhesive layer,
wherein:
the quarter-wave film has a thickness of 10 μm to 70 μm,
the adhesive layer bonds together the polarizer and the quarter-wave film by phase change from a liquid phase, and
the curing layer contains an organic compound capable of absorbing ultraviolet rays.

2. The polarizing plate of claim 1, wherein a slow axis of the quarter-wave film and an absorption axis of the polarizer intersect at an angle of 30° to 60°.

3. The polarizing plate of claim 1, wherein, if a thickness of the adhesive layer is A μm, then: 0 μm<A≦5 μm.

4. The polarizing plate of claim 1, wherein, if a thickness of the polarizer is B μm, then: 1 μm<B≦15 μm.

5. The polarizing plate of claim 1, wherein:
the polarizer and the quarter-wave film are each in a form of a long film, and
a slow axis of the quarter-wave film is inclined at 30° to 60° relative to a length direction of the quarter-wave film.

6. The polarizing plate of claim 1, wherein the quarter-wave film contains a cellulose-based polymer or a polycarbonate-based polymer.

7. The polarizing plate of claim 1, wherein the adhesive layer is formed of a polyvinyl alcohol adhesive.

8. The polarizing plate of claim 1, wherein the adhesive layer is formed of an ultraviolet ray-curable adhesive.

9. The polarizing plate of claim 1, wherein an overcoat layer is formed on the curing layer.

10. The polarizing plate of claim 9, wherein the overcoat layer is a hard-coat layer.

11. A display device comprising a display cell and a polarizing plate disposed at one face of the display cell, wherein the polarizing plate is the polarizing plate of claim 1.

12. The display device of claim 11, further comprising a front window as an exterior cover at a side of the polarizing plate opposite from the display cell.

13. The display device of claim 12, wherein a filler fills between the front window and the polarizing plate.
